(19) United States
(12) Patent Application Publication
(10) Pub. No.: US 2026/0225952 A1
(43) Pub. Date: Aug. 6, 2026

(54) SLIDE BONDING APPARATUS

(71) Applicant: Singular Genomics Systems, Inc., San Diego, CA (US)

(72) Inventors: Brandon CHIMITS, San Diego, CA (US); Matthew KETTERER, Scottsdale (CA); Kevin MARSHALL, Poway, CA (US)

(21) Appl. No.: 19/531,022

(22) Filed: Feb. 5, 2026

Related U.S. Application Data
(60) Provisional application No. 63/754,807, filed on Feb. 6, 2025.
(60) Provisional application No. 63/829,314, filed on Jun. 24, 2025.

(51) Int. Cl. C03C 27/06

(52) U.S. Cl. CPC C03C 27/06

(57) ABSTRACT

Disclosed herein, inter alia, are systems and methods for joining two glass slides.

### CROSS-REFERENCES TO RELATED APPLICATIONS

This application claims the benefit of U.S. Provisional Application No. 63/754,807 filed Feb. 6, 2025, and U.S. Provisional Application No. 63/829,314 filed Jun. 24, 2025, each of which is incorporated herein by reference in their entirety and for all purposes.

### BACKGROUND

In laboratory and diagnostic applications, the formation of a reliable flow cell is critical for conducting controlled biological reactions and imaging processes. A flow cell typically comprises two precisely aligned glass slides: a functionalized planar slide that retains biological specimens and a complementary slide configured to define a reaction channel, complete with ports for the introduction and removal of fluids. Traditional methods for mating these slides, however, pose significant challenges. Misalignment can lead to inconsistent flow dynamics and compromised imaging quality, while improper sealing may result in fluid leaks, jeopardizing sample integrity and experimental outcomes. Furthermore, the fragile nature of glass increases the risk of chipping or breakage during assembly, particularly when high precision (i.e., within a tolerance of 100 microns) is typically required to ensure proper flow cell function. Thus, there is a critical need for a device that can securely mate these two slides, providing active alignment, a foolproof assembly process, and protection against damage, thereby enabling reliable, high-quality flow cell formation for a wide range of scientific and diagnostic applications. Existing approaches to bonding flow cell components often lack precise and repeatable pressure control, leading to inconsistent adhesion, air bubble entrapment, or excessive force that can cause fractures. Manual methods or imprecise roller systems may apply uneven pressure, resulting in misalignment, adhesive failure, or reduced flow cell performance. Disclosed herein, inter alia, are solutions to these and other problems in the art.

### BRIEF SUMMARY

In an aspect is a system for applying pressure to flow cell components, the system including: an outer housing; an input tray coupled to the housing, the input tray configured to slidingly receive a flow cell formed of a first flow cell component and a second flow cell component positioned in a juxtaposed relationship; an output tray coupled to the housing, the output tray configured to slidingly receive the flow cell from the input tray; an output tray actuator mechanically coupled to the output tray, wherein the output tray actuator can be actuated to move the output tray between a first position configured to receive the flow cell from the input tray and a second position configured to release the flow cell from the outer housing; a roller assembly inside the outer housing, the roller assembly including at least one roller configured to apply pressure to compress the first flow cell component and the second flow cell component as the flow cell passes from the input tray to the output tray; and a roller assembly actuator mechanically coupled to the roller assembly, wherein the roller assembly actuator can be actuated to cause at least one roller of the roller assembly to rotate and drive the flow cell toward the output tray from the input tray.

In an aspect is provided a method of using the system as described herein, including: slidingly inserting the flow cell into the input tray; rotating the roller assembly actuator such that the flow cell slides into the roller assembly and a first roller and a second roller compresses the flow cell therebetween; further rotating the roller assembly actuator so that the roller assembly drives the flow cell into the output tray while the output tray is in the first position; and actuating the output tray actuator to cause the output tray to move from the first position to the second position.

### BRIEF DESCRIPTION OF THE DRAWINGS

FIG. 1 shows a perspective view of a system configured to apply pressure to a flow cell with an output tray in a receive position.

FIG. 2 shows another perspective view of the system with the output tray in a release position.

FIG. 3 shows a first side view of the system showing an output tray actuator.

FIG. 4 shows a front view of the system.

FIG. 5 shows a second side view showing a roller assembly actuator.

FIGS. 6-9 show various operations of the system.

FIG. 10 shows the system with an outer housing removed and further shows an internal roller assembly.

FIG. 11 shows another implementation of the system that does not include an outer housing.

FIGS. 12-16 shows example steps of a method of operation of the system of FIG. 11.

FIG. 17 shows another implementation of the system.

### DETAILED DESCRIPTION

The aspects and embodiments described herein relate to a system configured to reliably affix two slides together to form a flow cell. In embodiments, the system is a benchtop device configured to bond mated slides together to form a flow cell by applying uniform pressure using rollers. In embodiments, the rollers are composed of a urethane material having an 80 A durometer rating to provide controlled compression and uniform force distribution. In embodiments, the rollers are spaced to define a gap of approximately 1.0 mm, enabling alignment and pressure application during bonding. In embodiments, the device applies a force of approximately 20 pounds to activate the pressure-sensitive adhesive, facilitating bonding without exceeding structural tolerances of the slides. In embodiments, the device is optimized for bonding both two-lane and four-lane flow cells. In embodiments, the device prevents cracking of two-lane flow cells by maintaining a safety factor of approximately 3.5 from the known breaking point (e.g., greater than 70 lbs), thereby minimizing failure risks during bonding.

### I. Definitions

All patents, patent applications, articles and publications mentioned herein, both supra and infra, are hereby expressly incorporated herein by reference in their entireties.

Unless defined otherwise herein, all technical and scientific terms used herein have the same meaning as commonly understood by one of ordinary skill in the art to which this disclosure belongs. Various scientific dictionaries that include the terms included herein are well known and available to those in the art. Although any methods and materials similar or equivalent to those described herein find use in the practice or testing of the disclosure, some preferred methods and materials are described. Accordingly, the terms defined immediately below are more fully described by reference to the specification as a whole. It is to be understood that this disclosure is not limited to the particular methodology, protocols, and reagents described, as these may vary, depending upon the context in which they are used by those of skill in the art. The following definitions are provided to facilitate understanding of certain terms used frequently herein and are not meant to limit the scope of the present disclosure.

As used herein, the singular terms “a”, “an”, and “the” include the plural reference unless the context clearly indicates otherwise. Reference throughout this specification to, for example, “one embodiment”, “an embodiment”, “another embodiment”, “a particular embodiment”, “a related embodiment”, “a certain embodiment”, “an additional embodiment”, or “a further embodiment” or combinations thereof means that a particular feature, structure or characteristic described in connection with the embodiment is included in at least one embodiment of the present disclosure. Thus, the appearances of the foregoing phrases in various places throughout this specification are not necessarily all referring to the same embodiment. Furthermore, the particular features, structures, or characteristics may be combined in any suitable manner in one or more embodiments.

As used herein, the term “about” means a range of values including the specified value, which a person of ordinary skill in the art would consider reasonably similar to the specified value. In embodiments, the term “about” means within a standard deviation using measurements generally acceptable in the art. In embodiments, about means a range extending to +/−10% of the specified value. In embodiments, about means the specified value.

Throughout this specification, unless the context requires otherwise, the words “comprise”, “comprises” and “comprising” will be understood to imply the inclusion of a stated step or element or group of steps or elements but not the exclusion of any other step or element or group of steps or elements. By “consisting of” is meant including, and limited to, whatever follows the phrase “consisting of.” Thus, the phrase “consisting of” indicates that the listed elements are required or mandatory, and that no other elements may be present. By “consisting essentially of” is meant including any elements listed after the phrase, and limited to other elements that do not interfere with or contribute to the activity or action specified in the disclosure for the listed elements. Thus, the phrase “consisting essentially of” indicates that the listed elements are required or mandatory, but that no other elements are optional and may or may not be present depending upon whether or not they affect the activity or action of the listed elements.

In the description, relative terms such as “before,” “after,” “above,” “below,” “up,” “down,” “top” and “bottom” as well as derivative thereof (e.g., “horizontally,” “downwardly,” “upwardly,” etc.) should be construed to refer to the orientation as then described or as shown in the drawing or figure under discussion. These relative terms are for convenience of description and do not require that the system be constructed or operated in a particular orientation.

As used herein, the term “contacting” is used in accordance with its plain ordinary meaning and refers to the process of allowing at least two distinct species (e.g., chemical compounds, biomolecules, nucleotides, binding reagents, or cells) to become sufficiently proximal to react, interact or physically touch. However, the resulting reaction product can be produced directly from a reaction between the added reagents or from an intermediate from one or more of the added reagents that can be produced in the reaction mixture. The term “contacting” may include allowing two species to react, interact, or physically touch, wherein the two species may be a compound, a protein (e.g., an antibody), substrate, device, or enzyme.

A “functionalized” solid support, as used herein, may refer to the post hoc conjugation of a moiety to a functional group on the surface of a solid support.

As used herein, the term “polymer” refers to macromolecules having one or more structurally unique repeating units. The repeating units are referred to as “monomers,” which are polymerized for the polymer. Typically, a polymer is formed by monomers linked in a chain-like structure. A polymer formed entirely from a single type of monomer is referred to as a “homopolymer.” A polymer formed from two or more unique repeating structural units may be referred to as a “copolymer.” A polymer may be linear or branched, and may be random, block, polymer brush, hyperbranched polymer, bottlebrush polymer, dendritic polymer, or polymer micelles. The term “polymer” includes homopolymers, copolymers, tripolymers, tetra polymers and other polymeric molecules made from monomeric subunits. Copolymers include alternating copolymers, periodic copolymers, statistical copolymers, random copolymers, block copolymers, linear copolymers and branched copolymers. The term “polymerizable monomer” is used in accordance with its meaning in the art of polymer chemistry and refers to a compound that may covalently bind chemically to other monomer molecules (such as other polymerizable monomers that are the same or different) to form a polymer.

Polymers can be hydrophilic, hydrophobic or amphiphilic, as known in the art. Thus, “hydrophilic polymers” are substantially miscible with water and include, but are not limited to, polyethylene glycol and the like. “Hydrophobic polymers” are substantially immiscible with water and include, but are not limited to, polyethylene, polypropylene, polybutadiene, polystyrene, polymers disclosed herein, and the like. “Amphiphilic polymers” have both hydrophilic and hydrophobic properties and are typically copolymers having hydrophilic segment(s) and hydrophobic segment(s). Polymers include homopolymers, random copolymers, and block copolymers, as known in the art. The term “homopolymer” refers, in the usual and customary sense, to a polymer having a single monomeric unit. The term “copolymer” refers to a polymer derived from two or more monomeric species. The term “random copolymer” refers to a polymer derived from two or more monomeric species with no preferred ordering of the monomeric species. The term “block copolymer” refers to polymers having two or homopolymer subunits linked by covalent bond. Thus, the term “hydrophobic homopolymer” refers to a homopolymer which is hydrophobic. The term “hydrophobic block copolymer” refers to two or more homopolymer subunits linked by covalent bonds and which is hydrophobic.

As used herein, the term “hydrogel” refers to a three-dimensional polymeric structure that is substantially insoluble in water, but which is capable of absorbing and retaining large quantities of water to form a substantially stable, often soft and pliable, structure. In embodiments, water can penetrate in between polymer chains of a polymer network, subsequently causing swelling and the formation of a hydrogel. In embodiments, hydrogels are super-absorbent (e.g., containing more than about 90% water) and can include natural or synthetic polymers. In some embodiments, the hydrogel polymer includes 60-90% fluid, such as water, and 10-30% polymer. In certain embodiments, the water content of hydrogel is about 70-80%.

Hydrogels may be prepared by cross-linking hydrophilic biopolymers or synthetic polymers. Thus, in some embodiments, the hydrogel may include a crosslinker. As used herein, the term “crosslinker” refers to a molecule that can form a three-dimensional network when reacted with the appropriate base monomers. Examples of the hydrogel polymers, which may include one or more crosslinkers, include but are not limited to, hyaluronans, chitosans, agar, heparin, sulfate, cellulose, alginates (including alginate sulfate), collagen, dextrans (including dextran sulfate), pectin, carrageenan, polylysine, gelatins (including gelatin type A), agarose, (meth)acrylate-oligolactide-PEO-oligolactide-(meth)acrylate, PEO—PPO-PEO copolymers (Pluronics), poly(phosphazene), poly(methacrylates), poly(N-vinylpyrrolidone), PL(G)A-PEO-PL(G)A copolymers, poly(ethylene imine), polyethylene glycol (PEG)-thiol, PEG-acrylate, acrylamide, N, N′-bis(acryloyl)cystamine, PEG, polypropylene oxide (PPO), polyacrylic acid, poly(hydroxyethyl methacrylate) (PHEMA), poly(methyl methacrylate) (PMMA), poly(N-isopropylacrylamide) (PNIPAAm), poly(lactic acid) (PLA), poly(lactic-co-glycolic acid) (PLGA), polycaprolactone (PCL), poly(vinylsulfonic acid) (PVSA), poly(L-aspartic acid), poly(L-glutamic acid), bisacrylamide, diacrylate, diallylamine, triallylamine, divinyl sulfone, diethyleneglycol diallyl ether, ethyleneglycol diacrylate, polymethyleneglycol diacrylate, polyethyleneglycol diacrylate, trimethylopropoane trimethacrylate, ethoxylated trimethylol triacrylate, or ethoxylated pentaerythritol tetracrylate, or combinations thereof. Thus, for example, a combination may include a polymer and a crosslinker, for example polyethylene glycol (PEG)-thiol/PEG-acrylate, acrylamide/N,N′-bis(acryloyl)cystamine (BACy), or PEG/polypropylene oxide (PPO).

As used herein, the term “infrared (IR) reflective coating” refers to a material deposited onto a solid support capable of reflecting some or all infrared light. The effectiveness of an IR reflective coating is noted in its capability to reflect light that falls within the infrared spectrum, specifically light with wavelengths ranging from about 750 nanometers (nm) to about 1,000 micrometers (μm). Examples of IR reflective coating include, but are not limited to, metal oxides and silver. In embodiments, the infrared (IR) reflective coatings may include materials such as gold, aluminum, tantalum oxide, chromium, zinc sulfide, and titanium dioxide. Gold is known for its excellent reflectivity, particularly in the near-infrared range; aluminum is a lightweight metal with a natural oxide layer that enhances its IR reflectivity; chromium, a metal noted for its durable and reflective characteristics, zinc sulfide, a compound frequently used in optical components due to its transparency and reflectivity in the infrared range, and titanium dioxide, a compound widely used for its high refractive index and strong IR reflective properties, are exemplary of the diverse range of materials that can be employed as IR reflective coatings. In embodiments, the infrared (IR) reflective coating includes one or more layers of silicon dioxide (SiO₂) and tantalum pentoxide (Ta₂O₅). The IR reflective coating may reflect a portion of the total radiation.

As used herein, the term “interfacial”, or “interfacial layer”, is used in accordance with its plain ordinary meaning and refers to the boundary between any two bulk phases (gas, liquid, or solid) in contact where the properties differ from the properties of the bulk phases. In embodiments, an interfacial layer includes water. Interfacial water differs from bulk water in a number of properties, for example, interfacial water has a higher heat capacity than bulk water because more energy is necessary to break its hydrogen bonds. The arrangement and structure of the interfacial water layer varies depending on the structure of the hydrophilic and/or hydrophobic surface(s) the water layer is in contact with. Additional properties of interfacial water may be found in, e.g., Mentre P. J. Biol. Phys. and Chem. 2004; 4:115-123 and Tanaka M. Front. Chem. 2020; 8:165, which are incorporated herein by reference in their entirety.

As used herein, the terms “solid support” and “substrate” and “substrate surface” and “solid surface” refers to discrete solid or semi-solid substrate. In embodiments, a plurality of functional groups (e.g., bioconjugate reactive moieties or specific binding reagents) may be attached to the substrate. A solid support may encompass any type of solid, porous, or hollow sphere, ball, cylinder, or other similar configuration composed of plastic, ceramic, metal, or polymeric material (e.g., hydrogel) onto which a nucleic acid may be immobilized (e.g., covalently or non-covalently). A solid support may include a discrete particle that may be spherical (e.g., microspheres) or have a non-spherical or irregular shape, such as cubic, cuboid, pyramidal, cylindrical, conical, oblong, or disc-shaped, and the like. A bead can be non-spherical in shape. A solid support may be used interchangeably with the term “bead.” A solid support may further include a polymer or hydrogel on the surface to which the primers are attached. Exemplary solid supports include, but are not limited to, glass and modified or functionalized glass, plastics (including acrylics, polystyrene and copolymers of styrene and other materials, polypropylene, polyethylene, polybutylene, polyurethanes, Teflon™, cyclic olefin copolymers, polyimides etc.), nylon, ceramics, resins, Zeonor®, silica or silica-based materials including silicon and modified silicon, carbon, metals, inorganic glasses, optical fiber bundles, photopatternable dry film resists, UV-cured adhesives and polymers. Particularly useful solid supports for some embodiments have at least one surface located on a microplate. Particularly useful solid supports for some embodiments have at least one surface located on a microplate within a flow cell. Solid surfaces can also be varied in their shape depending on the application in a method described herein. For example, a solid surface useful herein can be planar, or contain regions which are concave or convex. In embodiments, the geometry of the concave or convex regions (e.g., wells) of the solid surface conform to the size and shape of a substantially circular particle to maximize the contact between the particle. In embodiments, the wells of an array are randomly located such that nearest neighbor wells have random spacing between each other. Alternatively, in embodiments the spacing between the wells can be ordered, for example, forming a regular pattern. The term solid substrate is encompassing of a substrate (e.g., a microplate or flow cell) having a surface including a polymer coating covalently attached thereto.

Broadly speaking, for nucleic acid sequencing applications and spatial biology, a flow cell may be considered a reaction chamber that contains one or more nucleic acid templates, to which nucleotides and ancillary reagents are iteratively applied and washed away. The flow cell allows for imaging of the sites at which the nucleic acids are bound, and resulting image data is used for the desired analysis.

In embodiments, the solid substrate is a flow cell. The term “flow cell” as used herein refers to a chamber including a solid surface across which one or more fluid reagents can be flowed. Examples of flow cells and related fluidic systems and detection platforms that can be readily used in the methods of the present disclosure are described, for example, in Bentley et al., Nature 456:53-59 (2008). In certain embodiments a substrate includes a surface (e.g., a surface of a flow cell, a surface of a tube, a surface of a chip), for example a metal surface (e.g., steel, gold, silver, aluminum, silicon and copper). In embodiments a substrate (e.g., a substrate surface) is coated and/or includes functional groups and/or inert materials. In certain embodiments a substrate includes a bead, a chip, a capillary, a plate, a membrane, a wafer (e.g., silicon wafers), a comb, or a pin for example. In some embodiments a substrate includes a bead and/or a nanoparticle. A substrate can be made of a suitable material, non-limiting examples of which include a plastic or a suitable polymer (e.g., polycarbonate, poly(vinyl alcohol), poly(divinylbenzene), polystyrene, polyamide, polyester, polyvinylidene difluoride (PVDF), polyethylene, polyurethane, polypropylene, and the like), borosilicate, glass, nylon, Wang resin, Merrifield resin, metal (e.g., iron, a metal alloy, sepharose, agarose, polyacrylamide, dextran, cellulose and the like or combinations thereof. In embodiments a substrate includes a magnetic material (e.g., iron, nickel, cobalt, platinum, aluminum, and the like). In embodiments a substrate includes a magnetic bead (e.g., DYNABEADS®, hematite, AMPure XP). Magnets can be used to purify and/or capture nucleic acids bound to certain substrates (e.g., substrates including a metal or magnetic material). The flow cell is typically a glass slide containing small fluidic channels (e.g., a glass slide 75 mm×25 mm×1 mm having one or more channels), through which sequencing solutions (e.g., polymerases, nucleotides, and buffers) may traverse. Though typically glass, suitable flow cell materials may include polymeric materials, plastics, silicon, quartz (fused silica), Borofloat® glass, silica, silica-based materials, carbon, metals, an optical fiber or optical fiber bundles, sapphire, or plastic materials such as COCs and epoxies. The particular material can be selected based on properties desired for a particular use. For example, materials that are transparent to a desired wavelength of radiation are useful for analytical techniques that will utilize radiation of the desired wavelength. Conversely, it may be desirable to select a material that does not pass radiation of a certain wavelength (e.g., being opaque, absorptive, or reflective). In embodiments, the material of the flow cell is selected due to the ability to conduct thermal energy. In embodiments, a flow cell includes inlet and outlet ports and a flow channel extending there between. In embodiments, the term “flow cell” refers to a vessel having a chamber (e.g., a flow channel or “lane”) where a reaction can be carried out, an inlet for delivering reagent(s) to the chamber, and an outlet for removing reagent(s) from the chamber.

As used herein, the term “channel” refers to a passage in or on a substrate material that directs the flow of a fluid. A channel may run along the surface of a substrate, or may run through the substrate between openings in the substrate. A channel can have a cross section that is partially or fully surrounded by substrate material (e.g., a fluid impermeable substrate material). For example, a partially surrounded cross section can be a groove, trough, furrow or gutter that inhibits lateral flow of a fluid. The transverse cross section of an open channel can be, for example, U-shaped, V-shaped, curved, angular, polygonal, or hyperbolic. A channel can have a fully surrounded cross section such as a tunnel, tube, or pipe. A fully surrounded channel can have a rounded, circular, elliptical, square, rectangular, or polygonal cross section. In particular embodiments, a channel can be located in a flow cell, for example, being embedded within the flow cell. A channel in a flow cell can include one or more windows that are transparent to light in a particular region of the wavelength spectrum. In embodiments, the channel contains one or more polymers of the disclosure. In embodiments, the channel is filled by the one or more polymers, and flow through the channel (e.g., as in a sample fluid) is directed through the polymer in the channel. In embodiments, the tissue is in a channel of a flow cell.

As used herein, the term “gasket” refers to an element that separates the first solid support and the second solid support to define a reaction chamber on the second solid support, wherein the reaction chamber includes a defined gap or channel through which liquid can flow or be contained. In embodiments, a gasket is a spacer element. In embodiments, the thickness (also referred herein as the “depth” or “height” of the channel) may be altered by modulating the height of the gasket or spacer element. In embodiments, the gasket or spacer element includes a peel-off backing designed to form a sealed reaction chamber on the second solid support when adhered to the first solid support. This design ensures the creation of defined channels necessary for fluid flow and biochemical reactions within the assembled flow cell (e.g., flow cell assembly described herein). An example of a gasket or spacer element includes, but is not limited to, those used in the NovaSeq™6000 S4 flow cells, commercialized by Illumina®, which is depicted in Poovathingal et al. (doi: 10.1101/2024.02.22.581576).

As used herein, the term “reaction chamber” refers to a contained space or vessel designed for conducting chemical, biological, or physical reactions. A reaction chamber may include features such as inlets and outlets for introducing and removing substances, sensors for monitoring reaction conditions, and mechanisms for agitation or mixing. In embodiments, the reaction chamber is a part of the flow cell where the cell or tissue is in contact with the fluids (e.g., buffers), polymerases, nucleotides, and reagents used for the methods described herein. In embodiments, the reaction chamber is formed when a first solid support and a second solid support configured to provide a channel are attached together. In embodiments, the reaction chamber is an enclosed (i.e., closed) container containing one or two openings for introducing and removing fluids and reagents.

The term “surface” is intended to mean an external part or external layer of a substrate. The surface can be in contact with another material such as a gas, liquid, gel, polymer, organic polymer, second surface of a similar or different material, metal, or coat. The surface, or regions thereof, can be substantially flat. The substrate and/or the surface can have surface features such as wells, pits, channels, ridges, raised regions, pegs, posts or the like.

As used herein, the term “feature” refers a point or area in a pattern that can be distinguished from other points or areas according to its relative location. An individual feature can include one or more polynucleotides. For example, a feature can include a single target nucleic acid molecule having a particular sequence or a feature can include several nucleic acid molecules having the same sequence (and/or complementary sequence, thereof). Different molecules that are at different features of a pattern can be differentiated from each other according to the locations of the features in the pattern. Non-limiting examples of features include wells in a substrate, particles (e.g., beads) in or on a substrate, polymers in or on a substrate, projections from a substrate, ridges on a substrate, or channels in a substrate. In embodiments, the one or more features include a reaction chamber and its contents. In embodiments, the one or more features includes a target (e.g., a nucleic acid, protein, or biomarker), a cell, or a tissue sample. In embodiments, the feature is a nucleotide (e.g., a fluorescently labeled nucleotide). In embodiments, the feature is a nucleic acid. In embodiments, the feature is a protein. In embodiments, the feature is a biomolecule.

As used herein, the terms “sequencing”, “sequence determination”, and “determining a nucleotide sequence”, are used in accordance with their ordinary meaning in the art, and refer to determination of partial as well as full sequence information of the nucleic acid being sequenced, and particular physical processes for generating such sequence information. That is, the term includes sequence comparisons, fingerprinting, and like levels of information about a target nucleic acid, as well as the express identification and ordering of nucleotides in a target nucleic acid. The term also includes the determination of the identification, ordering, and locations of one, two, or three of the four types of nucleotides within a target nucleic acid. As used herein, the term “sequencing cycle” is used in accordance with its plain and ordinary meaning and refers to incorporating one or more nucleotides (e.g., nucleotide analogues) to the 3′ end of a polynucleotide with a polymerase, and detecting one or more labels that identify the one or more nucleotides incorporated. In embodiments, one nucleotide (e.g., a modified nucleotide) is incorporated per sequencing cycle. The sequencing may be accomplished by, for example, sequencing by synthesis, pyrosequencing, and the like. In embodiments, a sequencing cycle includes extending a complementary polynucleotide by incorporating a first nucleotide using a polymerase, wherein the polynucleotide is hybridized to a template nucleic acid, detecting the first nucleotide, and identifying the first nucleotide. In embodiments, to begin a sequencing cycle, one or more differently labeled nucleotides and a DNA polymerase can be introduced. Following nucleotide addition, signals produced (e.g., via excitation and emission of a detectable label) can be detected to determine the identity of the incorporated nucleotide (based on the labels on the nucleotides). Reagents can then be added to remove the 3′ reversible terminator and to remove labels from each incorporated base. Reagents, enzymes, and other substances can be removed between steps by washing. Cycles may include repeating these steps, and the sequence of each cluster is read over the multiple repetitions.

The terms “bind” and “bound” as used herein are used in accordance with their plain and ordinary meanings and refer to an association between atoms or molecules. The association can be direct or indirect. For example, bound atoms or molecules may be directly bound to one another, e.g., by a covalent bond or non-covalent bond (e.g. electrostatic interactions (e.g. ionic bond, hydrogen bond, halogen bond), van der Waals interactions (e.g. dipole-dipole, dipole-induced dipole, London dispersion), ring stacking (pi effects), hydrophobic interactions and the like). As a further example, two molecules may be bound indirectly to one another by way of direct binding to one or more intermediate molecules (e.g., as in a substrate, bound to a first antibody, bound to an analyte, bound to a second antibody), thereby forming a complex. As used herein, the term “attached” refers to the state of two things being joined, fastened, adhered, connected or bound to each other. For example, a sample such as a cell or tissue, can be attached to a material, such as a hydrogel, polymer, or solid support, by a covalent or non-covalent bond. In embodiments, attachment is a covalent attachment.

As used herein, the term “tissue” is used in accordance with its plain and ordinary meaning and refers to an organization of cells in a structure, where the structure generally functions as a unit in an organism (e.g., mammals) and may carry out specific functions. In some examples, cells in a tissue are configured in a mass and may not be free from one another. This disclosure describes methods of obtaining single biological samples (e.g., cells or nuclei) from tissues that can be used in various single biological samples (e.g., single-cell/nucleus) workflows. In some examples, blood cells (e.g., lymphocytes) can be considered a tissue. However, blood cells, like lymphocytes, generally are free from one another in the blood. The methods disclosed herein can be used to process those cells to obtain cells and/or nuclei, although dissociation steps may not be necessary when using those types of tissues. Generally, any type of tissue can be used in the methods described herein. Examples of tissues that may be used in the disclosed methods include, but are not limited to connective, epithelial, muscle and nervous tissue. In some examples, the tissues are from mammals. Tissues that contain any type of cells may be used. For example, tissues from abdomen, bladder, brain, esophagus, heart, intestine, kidney, liver, lung, lymph node, olfactory bulb, ovary, pancreas, skin, spleen, stomach, testicle, and the like. The tissue may be normal or tumor tissue (e.g., malignant). This example is not meant to be limiting. Although the conditions used in the disclosed may not be identical for different types of tissue, the methods may be applied to any tissue. The tissues used in the disclosed methods may be in various states. In some examples, the tissues used in the disclosed methods may be fresh, frozen, or fixed.

The term “image” is used according to its ordinary meaning and refers to a representation of all or part of an object. The representation may be an optically detected reproduction. For example, an image can be obtained from fluorescent, luminescent, scatter, or absorption signals. The part of the object that is present in an image can be the surface or other xy plane of the object. Typically, an image is a 2 dimensional representation of a 3 dimensional object. An image may include signals at differing intensities (i.e., signal levels). An image can be provided in a computer readable format or medium. An image is derived from the collection of focus points of light rays coming from an object (e.g., the sample), which may be detected by any image sensor.

The term “adhesion strength” or “attachment strength” as used herein refers to the interfacial force bonding two materials together. The adhesion strength may refer to the minimal amount of force necessary to detach and/or remove the two materials. Means for quantifying adhesion strength are known in the art, for example with a pull-off adhesion test. A pull-off adhesion test measures the resistance of a substance (e.g., a tissue sample) from a substrate (e.g., a carrier substrate) when a perpendicular tensile force is applied to the substance. As outlined in the American Society for Testing and Materials (ASTM) D4541 (and similarly in BS EN ISO 4624), the test may include attaching a test dolly to the substance (e.g., the tissue sample) and then pulling the dolly by exerting a force perpendicular to the surface in an effort to remove the dolly with the substance from the substrate. An alternative testing approach is outlined in ASTM D6677 which utilizes a utility knife to peel the substance away from the substrate and ASTM D3359 which uses a pressure sensitive tape. The peel strength tests employed for examining the strength of Band-Aid® bonds is provided in ASTM D903, ASTM D1876, and ASTM F2258, each of which are incorporated herein by reference and may be used for measuring the adhesion strength as described herein. Instruments for performing such measurements include the monotonic uniaxial tensile testing device provided by Bose® Biodynamic Test Instrument, Minnetonka, MN, for example by employing at a constant rate (e.g., 0.05 mm/sec) and continuously recording the load response (e.g., 200 measurements/sec) to the point of macroscopic failure, or the Avery Adhesive Test (AAT).

The term “port” is used in accordance with its plain ordinary meaning and refers to a designated entry or exit point on the device where fluids, gases, or other substances can be introduced into or removed from the microfluidic system. Ports are typically small and precise to accommodate the scaled-down dimensions of microfluidic channels and chambers. For example, the solid support may include an inlet port, that is, a port through which fluids (such as reagents, samples, or solvents) are introduced into the microfluidic device. The solid support may include an outlet port through which fluids exit the microfluidic device. In embodiments, the inlet and outlet ports are distinct and separate. In embodiments, the inlet port and the outlet ports are the same.

As used herein, the term “inlet” or “inlet port” refers to the location on a flow cell assembly where the reagents and fluids used for methods described herein enters the flow cell. As used herein, the term “outlet” or “outlet port” refers to the location on a flow cell assembly where the reagents and fluids used for methods described herein exits the flow cell after contacting the reaction chamber containing the cell or tissue to be analyzed.

The term “platen” is used in accordance with its plain ordinary meaning and refers to a flat platform. The platform composition may include a substantially rigid material, for example, but not limited to, polymers, metals, inorganic oxide materials, such as glasses and sapphire-based materials, and ceramics. In embodiments, the platen includes a surface coating. Numerous surface coatings are possible, such as a polymer thin film, where the polymer may be selected from a range of physical and surface chemistry properties, such as, for example polyhalohydrocarbon, polystyrene, polyamide, polyimide and the like. Alternatively, a surface coating could be an inorganic coating, such as a silicon nitride, silicon carbide, silicon oxide, or diamond. In embodiments, a platen is a substantially planar platform.

The term “align” or “alignment” is used in accordance with its ordinary meaning and refers to perfect alignment and alignment with relatively small, insignificant amount of deviation/misalignment (e.g., ≤5%).

The term “nip” is used in accordance with its plain ordinary meaning and refers to a contact region defined between opposed rollers (or between a roller and an opposing surface) where an article passing therebetween is compressed. In embodiments, the nip is defined as a minimum-gap region between a first roller and a second roller through which the flow cell is advanced. In embodiments, the nip defines a compression zone configured to apply a compressive load to the flow cell sufficient to activate an adhesive disposed between a first slide and a second slide. In embodiments, the nip is configured to provide substantially uniform compressive loading across a width of the flow cell as the flow cell passes between the rollers. In embodiments, the nip is configured to accommodate dimensional tolerances of the flow cell by permitting controlled roller displacement via a compliance mechanism. In embodiments, the nip is defined by a roller spacing selected to control at least one of a peak compressive force, an average compressive force, or a contact pressure applied to the flow cell. In embodiments, the nip is configured to maintain continuous contact with the flow cell during advancement to reduce localized stress concentrations and promote uniform bonding. In embodiments, a method of bonding comprises advancing the flow cell into the nip such that the first roller and the second roller compress the flow cell therebetween while the rollers rotate to drive the flow cell through the compression zone.

It is understood that the examples and embodiments described herein are for illustrative purposes only and that various modifications or changes in light thereof will be suggested to persons skilled in the art and are to be included within the spirit and purview of this application and scope of the appended claims. All publications, patents, and patent applications cited herein are hereby incorporated by reference in their entirety for all purposes.

### II. Systems & Devices

In an aspect is a system for applying pressure to flow cell components, the system including: an outer housing; an input tray coupled to the housing, the input tray configured to slidingly receive a flow cell formed of a first flow cell component and a second flow cell component positioned in a juxtaposed relationship; an output tray coupled to the housing, the output tray configured to slidingly receive the flow cell from the input tray; an output tray actuator mechanically coupled to the output tray, wherein the output tray actuator can be actuated to move the output tray between a first position configured to receive the flow cell from the input tray and a second position configured to release the flow cell from the outer housing; a roller assembly inside the outer housing, the roller assembly including at least one roller configured to apply pressure to compress the first flow cell component and the second flow cell component as the flow cell passes from the input tray to the output tray; and a roller assembly actuator mechanically coupled to the roller assembly, wherein the roller assembly actuator can be actuated to cause at least one roller of the roller assembly to rotate and drive the flow cell toward the output tray from the input tray.

In another aspect is provided a system for applying pressure to flow cell components, the system comprising: a support structure defining an input region and an output region; a roller assembly including a first roller and a second roller defining a nip configured to compress a flow cell as the flow cell advances from the input region toward the output region; and an actuator operably coupled to at least one of the first roller or the second roller, the actuator configured to rotate the at least one roller to advance the flow cell through the nip.

In embodiments, the first flow cell component is a glass slide component and the second flow cell component is a tissue slide component juxtaposed with the glass slide component. In embodiments, the first flow cell component is a glass slide component, which may be a planar body formed from optically transparent material suitable for microscopy, imaging, or biochemical analysis. The glass slide component can have a uniform thickness and surface treatment to enhance adhesive bonding, fluid flow dynamics, or optical clarity. In embodiments, the second flow cell component is a tissue slide component juxtaposed with the glass slide component. In embodiments, the first flow cell component and/or the second flow cell component may be formed from glass, polymer, or other biocompatible materials designed to support biological samples, chemical reagents, or diagnostic assays. The juxtaposed relationship between the glass slide component and the tissue slide component defines an internal fluidic channel (e.g., a reaction chamber) when bonded, enabling controlled movement of reagents, samples, or fluids across the surface of the flow cell. In embodiments, the tissue slide component and the glass slide component may be pre-treated with surface coatings, chemical functionalization, or hydrophilic/hydrophobic patterning to enhance adhesion, fluid control, or sample retention. The bonding of these components may be facilitated by pressure-sensitive adhesives, thermal bonding, or other sealing techniques optimized for maintaining structural integrity while preventing leakage or delamination.

In embodiments, the first flow cell component and the second flow cell component are flat, planar bodies. In embodiments, the planar bodies may include optional features such as microchannels, alignment guides, or surface treatments to enhance adhesion, fluid flow, or sample retention. These features can be fabricated through etching, molding, or deposition techniques to tailor the flow cell for specific analytical or diagnostic applications.

In embodiments, the first slide and/or the second slide includes a hydrogel. In embodiments, the first slide and/or the second slide includes a polymer attached to the slide. In embodiments, the polymer is a photoresist, wherein the photoresist is a polydimethylsiloxane (PDMS), poly(methyl methacrylate) (PMMA), cyclic olefin copolymer (COC), silsesquioxane resist, an epoxy-based polymer resist, poly(vinylpyrrolidone-vinyl acrylic acid) copolymer resist, an Off-stoichiometry thiol-enes (OSTE) resist, amorphous fluoropolymer resist, a crystalline fluoropolymer resist, polysiloxane resist, or an organically modified ceramic polymer resist. In embodiments, the polymer attached to the slide includes acrylate silanes and polyamines. In embodiments, the polymer attached to the slide includes methacrylic acid N-hydroxysuccinimide ester (NHS-MA). In embodiments, the polymer attached to the slide includes (3-aminopropyl)triethoxysilane (APTES). In embodiments, the polymer attached to the slide includes a copolymer of (3-aminopropyl)triethoxysilane (APTES) and methacrylic acid N-hydroxysuccinimide ester (NHS-MA).

The photoresist (alternatively referred to as a resist) is an active material layer that can be patterned by selective exposure and must “resist” chemical/physical attach of the underlying substrate. A photoresist is a light-sensitive polymer material used to form a patterned coating on a surface. The process begins by coating a substrate (e.g., a glass substrate) with a light-sensitive organic material. A mask with the desired pattern is used to block light so that only unmasked regions of the material will be exposed to light. In the case of a positive photoresist, the photosensitive material is degraded by light and a suitable solvent will dissolve away the regions that were exposed to light, leaving behind a coating where the mask was placed. In the case of a negative photoresist, the photosensitive material is strengthened (either polymerized or cross-linked) by light, and a suitable solvent will dissolve away only the regions that were not exposed to light, leaving behind a coating in areas where the mask was not placed. In embodiments, the slide includes an epoxy-based photoresist (e.g., SU-8, SU-8 2000, SU-8 3000, SU-8GLM 2060 ). In embodiments, the slide includes a negative photoresist. Negative refers to a photoresist whereby the parts exposed to UV become cross-linked (i.e., immobilized), while the remainder of the polymer remains soluble and can be washed away during development.

In embodiments, the slide includes a glass substrate having a surface coated in silsesquioxane resist (e.g., polyhedral oligosilsesquioxanemethacrylate (POSS)), an epoxy-based polymer resist (e.g., SU-8 as described in U.S. Pat. No. 4,882,245), poly(vinylpyrrolidone-vinyl acrylic acid) copolymer resist (e.g., as described in U.S. Pat. No. 7,467,632), or novolaks resist, bisazides resist, or a combination thereof (e.g., as described in U.S. Pat. No. 4,970,276). In embodiments, the resist is removed prior to loading.

A “resist” as used herein is used in accordance with its ordinary meaning in the art of lilthography and refers to a polymer matrix (e.g., a polymer network). In embodiments, the photoresist is a silsesquioxane resist. In embodiments, the photoresist is an epoxy-based polymer resist. In embodiments, the photoresist is a poly(vinylpyrrolidone-vinyl acrylic acid) copolymer resist. In embodiments, the photoresist is an Off-stoichiometry thiol-enes (OSTE) resist. In embodiments, the slide includes a Hydrogen Silsesquioxane (HSQ) polymer (e.g., HSQ resist). In embodiments, the photoresist is an amorphous fluoropolymer resist. In embodiments, the photoresist is a crystalline fluoropolymer resist. In embodiments, the photoresist is a polysiloxane resist. In embodiments, the photoresist is an organically modified ceramic polymer resist. In embodiments, the photoresist includes polymerized alkoxysilyl methacrylate polymers and metal oxides (e.g., SiO₂, ZrO, MgO, Al₂O₃, TiO₂ or Ta₂O₅). In embodiments, the photoresist includes polymerized alkoxysilyl acrylate polymers and metal oxides (e.g., SiO₂, ZrO, MgO, Al₂O₃, TiO₂ or Ta₂O₅). In embodiments, the photoresist includes metal atoms, such as Si, Zr, Mg, Al, Ti or Ta atoms. In embodiments, the slide includes a resist (e.g., a nanoimprint lithography (NIL) resist). Nanoimprint resists can include thermal curable materials (e.g., thermoplastic polymers), and/or UV-curable polymers. In embodiments, the slide is generated by pressing a transparent mold possessing the pattern of interest (e.g., the pattern of wells) into photo-curable liquid film, followed by solidifying the liquid materials via a UV light irradiation. Typical UV-curable resists have low viscosity, low surface tension, and suitable adhesion to the glass substrate. For example, the slide surface is coated in an organically modified ceramic polymer (ORMOCER®, registered trademark of Fraunhofer-Gesellschaft zur Förderung der angewandten Forschung e. V. in Germany). Organically modified ceramics contain organic side chains attached to an inorganic siloxane backbone. Several ORMOCER® polymers are now provided under names such as “Ormocore”, “Ormoclad” and “Ormocomp” by Micro Resist Technology GmbH. In embodiments, the slide includes a resist as described in Haas et al Volume 351, Issues 1-2, 30 Aug. 1999, Pages 198-203, US 2015/0079351A1, US2008/0000373, US 2010/0160478, or U.S. Pat. No. 10,268,096 B2, each of which is incorporated herein by reference. In embodiments, the slide surface is coated in an organically modified ceramic polymer including (ORMOCER®, registered trademark of Fraunhofer-Gesellschaft zur Förderung der angewandten Forschung e. V. in Germany). In embodiments, the slide surface is coated in an organically modified ceramic polymer wherein the organically modified ceramic polymer includes an inorganic-organic hybrid polymer that includes Si—O bonds. In embodiments, the slide surface is coated in an organically modified ceramic polymer wherein the organically modified ceramic polymer includes an inorganic-organic hybrid polymer that includes Si—C bonds. In embodiments, the slide surface is coated in an organically modified ceramic polymer wherein the organically modified ceramic polymer includes free acrylate moieties. In embodiments, the polymer is an organically modified ceramic polymer wherein the organically modified ceramic polymer includes an inorganic-organic hybrid polymer that includes Si—O bonds. In embodiments, polymer is an organically modified ceramic polymer wherein the organically modified ceramic polymer includes an inorganic-organic hybrid polymer that includes Si-C bonds. In embodiments, the polymer is an organically modified ceramic polymer wherein the organically modified ceramic polymer includes free acrylate moieties. In embodiments, the polymer contains organically crosslinked heteropolysiloxane moieties.

In embodiments, the device provides a slide mating assembly designed for precise alignment and joining of two glass slides, with potential applications in fluid flow, tissue sample analysis, or other areas where accurate slide mating is essential. In embodiments, the slide mating assembly includes a first slide section, a second slide section, a hinge assembly, and a lock assembly, each working in concert to facilitate secure and accurate assembly and use of the slides. In embodiments, the device includes alignment features (e.g., 1, 2, 3, 4, 5, 6, 7, 8, 9, 10, 11, 12, 13, 14, 15, 16, 17, 18, 19, 20, or more alignment features) disposed at the outer edge of a receptacle within the slide mating assembly. In embodiments, the slide mating assembly has two alignment features. Alignment features include raised features (e.g., blocks) against which the glass slide can be in direct contact. Other examples of alignment features include, but are not limited to, pins, posts, protrusions, ridges, prongs, etc., that are brought into contact with or inserted into the glass slide and provide a physical barrier to movement.

In embodiments, the roller assembly includes a first roller and a second roller. In embodiments, the first roller and the second roller are relatively positioned to compress the flow cell between the first roller and the second roller as the flow cell moves from the input tray to the output tray. In embodiments, the rollers are spaced to define a gap from 0.2 mm to 3.0 mm. In embodiments, the rollers are spaced to define a gap from 0.5 mm to 1.5 mm. In embodiments, the rollers are spaced to define a gap of 0.8 mm to 1.2 mm. In embodiments, the rollers are spaced to define a gap of about 1.0 mm. In embodiments, the gap is adjustable via a lead screw, cam, eccentric, shim set, spacer block, or interchangeable gauge insert. In embodiments, the roller assembly includes a compliance mechanism comprising a spring, Belleville washer stack, elastomer mount, pneumatic cylinder, or linear actuator to maintain substantially constant contact pressure despite thickness variation of the flow cell.

In embodiments, the roller assembly includes a first roller and a second roller, each configured to rotate about a respective axis to apply uniform pressure to the flow cell as it advances from the input tray to the output tray. The first roller and the second roller may be cylindrical bodies composed of a resilient material selected to provide controlled compression without damaging the flow cell components. In embodiments, the first roller and the second roller are positioned relative to each other to define a gap for receiving the flow cell. The spacing between the rollers may be about 1.0, 1.1, 1.2, 1.3, 1.4, 1.5, 1.6, 1.7, 1.8, 1.9, or about 2.0 mm, which is optimized to allow for uniform pressure distribution while preventing excessive deformation of the flow cell components. The spacing may be adjustable in some implementations, allowing for accommodation of flow cells with varying thicknesses or material properties. The adjustment mechanism may include a spring-loaded system, threaded shafts, or mechanical shims that allow fine-tuning of the roller gap. In embodiments, the roller gap is set based on the chosen durometer and compressive force to facilitate easy insertion of the flow cell 112 while maintaining a repeatable and controlled rolling process. If the gap is too small (e.g., 0 mm), inserting a 1.7 mm thick assembled flow cell may be difficult, leading to misalignment or excess insertion force. Conversely, if the gap is too large, the compliance of the rollers may absorb the applied force before engaging the spring-loaded mechanism, resulting in inadequate pressure application. In embodiments, the spring-loaded roller assembly enables each flow cell undergoes a consistent and repeatable bonding process. The spring mechanism provides a controlled preloading effect, provided that the rollers engage with the flow cell at a defined force. The stiffness of the rollers also influences the maximum permissible gap, as excessive spacing may prevent proper engagement of the spring system, reducing the intended compressive force. In embodiments, the roller assembly actuator 135 is used to drive the rollers in a controlled motion, advancing the flow cell 112 from the input tray 110 to the output tray 115 at an optimal rolling speed. The directional movement of the rollers facilitates the controlled expulsion of air bubbles and aids in even distribution of adhesive across the bonding interface.

In embodiments, the slide includes an IR reflective coating. In embodiments, the IR reflective coating is attached to the slide. In embodiments, the IR reflective coating is attached to the slide, wherein the IR reflective coating is in contact with the polymer described herein. In embodiments, the IR reflective coating includes metal oxides. In embodiments, the IR reflective coating includes titanium dioxide, zinc oxide, tin oxide, tantalum pentoxide, silicon dioxide, indium tin oxide, silver-based coating, ceramic-based coating or a combination thereof. In embodiments, the IR reflective coating includes SiO₂, TiO₂, Al₂O₃ and Ta₂O₅ and fluorides such as MgF₂, LaF₃ and AlF₃. In embodiments, the IR reflective coating includes tantalum pentoxide (Ta₂O₅) and silicon dioxide (SiO₂). In embodiments, the infrared (IR) reflective coating includes one or more layers of silicon dioxide (SiO₂) and tantalum pentoxide (Ta₂O₅). In embodiments, the infrared (IR) reflective coating includes alternating layers of silicon dioxide (SiO₂) and tantalum pentoxide (Ta₂O₅), wherein the layer of silicon dioxide (SiO₂) is in direct or indirect contact with the polymer (e.g., the polymer described herein). In embodiments, the infrared (IR) reflective coating includes alternating layers of silicon dioxide (SiO₂) and tantalum pentoxide (Ta₂O₅), wherein the layer of tantalum pentoxide (Ta₂O₅) is in direct or indirect contact with the polymer (e.g., the polymer described herein).

In embodiments, the IR reflective coating reflects near-infrared radiation (NIR). In embodiments, the IR reflective coating reflects mid-or far-infrared radiation. In embodiments, the IR reflective coating reflects wavelengths greater than 750 nm. In embodiments, the IR reflective coating reflects wavelengths greater than 760 nm. In embodiments, the IR reflective coating reflects wavelengths greater than 770 nm. In embodiments, the IR reflective coating reflects wavelengths greater than 780 nm. In embodiments, the IR reflective coating reflects wavelengths greater than 790 nm. In embodiments, the IR reflective coating reflects wavelengths greater than 800 nm. In embodiments, the IR reflective coating reflects wavelengths from about 750 nm to 1,000 μm. In embodiments, the infrared (IR) reflective coating includes one or more layers of silicon dioxide (SiO₂) and tantalum pentoxide (Ta₂O₅). A multilayer configuration leverages the distinct optical properties of both materials to enhance the IR reflectivity. Silicon dioxide, known for its low refractive index, and tantalum pentoxide, recognized for its high refractive index, are alternately layered to create a stack that exhibits high reflectance in the infrared spectrum. The alternating layers of SiO₂ and Ta₂O₅ result in constructive interference of light at specific wavelengths, thereby enhancing the IR reflective capability of the coating. The number and thickness of these layers can be tailored to target specific wavelengths within the IR range, or permitting a certain percentage of radiation to transmit. For example, the IR reflective coating may reflect 2-3%, 2-6%, or 2 to 10% of the total IR radiation, and it absorbs or transmits the remaining IR radiation (e.g., greater than about 90% of the IR radiation). In embodiments, the IR reflective coating reflects about 1%, about 2%, about 3%, about 4%, about 5%, about 6%, about 7%, about 8%, about 9%, or about 10% of the total IR radiation.

In embodiments, the IR reflective coating aids autofocus mechanisms in optical instruments (e.g., fluorescence microscopy instruments) to provide consistent signal across various z-heights (e.g., the depth of an image). In embodiments, the IR reflective coating increases the amount of light reflected to the autofocus sensor to provide consistent signal across various z-heights. In embodiments, the IR reflective coating improves the signal to noise ratio of an image acquired by an optical instrument.

In embodiments, the first slide includes one or more channel(s). In embodiments, the first slide includes a channel bored into the first slide. In embodiments, the first slide includes a plurality of channels bored into the first slide. In embodiments, the first slide includes 2 channels bored into the first slide. In embodiments, the first slide includes 3 channels bored into the first slide. In embodiments, the first slide includes 4 channels bored into the first slide. In embodiments, the width of the channel is from about 1 to 5 mm. In embodiments, the width of the channel is from about 5 to 10 mm. In embodiments, the width of the channel is from about 10 to 15 mm. In embodiments, the width of the channel is from about 5 mm. In embodiments, the width of the channel is from about 11 mm.

In embodiments, the second slide includes one or more channel(s). In embodiments, the second slide includes a channel bored into the second slide. In embodiments, the second slide includes a plurality of channels bored into the second slide. In embodiments, the second slide includes 2 channels bored into the second slide. In embodiments, the second slide includes 3 channels bored into the second slide. In embodiments, the second slide includes 4 channels bored into the second slide. In embodiments, the width of the channel is from about 1 to 5 mm. In embodiments, the width of the channel is from about 5 to 10 mm. In embodiments, the width of the channel is from about 10 to 15 mm. In embodiments, the width of the channel is from about 5 mm. In embodiments, the width of the channel is from about 11 mm.

In embodiments, the second slide includes a gasket (alternatively referred to herein as a spacer), wherein the gasket defines the reaction chamber. In embodiments, the gasket defines a perimeter of a channel. In embodiments, the gasket defines a perimeter of two or more channels. In embodiments, the gasket includes silicone, polyimide, fluorocarbon elastomer, ethylene propylene diene, polychloroprene, polytetrafluoroethylene, nitrile rubber, butyl rubber, natural rubber, thermoplastic elastomer, or a combination thereof. In embodiments, the second slide includes a spacer element to form an offset surface. In embodiments, the second slide includes one or more channels. The channel(s) may be formed by affixing a spacer element to create a defined gap or channel through which liquid can flow or be contained. The spacer element may be made of any suitable material, for example resin, glass, plastic, silicon, an adhesive, or a combination thereof. In embodiments, the spacer element includes a first adhesive in contact with the functionalized glass slide and second adhesive in contact with the second slide. In embodiments, the spacer element includes a first adhesive in contact with the functionalized glass slide, a second adhesive in contact with the second slide, and a carrier material in contact with the first adhesive and the second adhesive. The depth of the resulting channel may be controlled by including a carrier material (e.g., one or more polymer or copolymer layers) between the adhesives. In embodiments, the spacer element may form the walls of the reaction chamber, wherein the reaction chamber includes the sample. In embodiments, the spacer element is further attached to the copolymer attached the polymer of the first slide. In embodiments, the gasket is referred to as a spacer element.

In embodiments, the flow cell assembly further includes 2, 3, 4, 5, 6, 7, 8, 9, 10, 11, or 12 reaction chambers (e.g., channels). In embodiments, the flow cell assembly includes 2 distinct reaction chambers (e.g., channels). In embodiments, the flow cell assembly includes 4 distinct reaction chambers (e.g., channels). In embodiments, each reaction chamber includes a depth of about 50 μm to about 150 μm. In embodiments, the reaction chamber includes a depth of about 80 μm to about 110 μm. In embodiments, the reaction chamber includes a width of about 4 μm to about 15 μm.

In embodiments, the reaction chamber is a channel on the flow cell. In embodiments, the channel includes a depth of about 50 μm to about 150 μm. In embodiments, the channel includes a depth of about 50 μm. In embodiments, the channel includes a depth of about 60 μm. In embodiments, the channel includes a depth of about 70 μm. In embodiments, the channel includes a depth of about 80 μm. In embodiments, the channel includes a depth of about 90 μm. In embodiments, the channel includes a depth of about 100 μm. In embodiments, the channel includes a depth of about 110 μm. In embodiments, the channel includes a depth of about 120 μm. In embodiments, the channel includes a depth of about 130 μm. In embodiments, the channel includes a depth of about 140 μm. In embodiments, the channel includes a depth of about 71 μm. In embodiments, the channel includes a depth of about 72 μm. In embodiments, the channel includes a depth of about 73 μm. In embodiments, the channel includes a depth of about 74 μm. In embodiments, the channel includes a depth of about 75 μm. In embodiments, the channel includes a depth of about 76 μm. In embodiments, the channel includes a depth of about 77 μm. In embodiments, the channel includes a depth of about 78 μm. In embodiments, the channel includes a depth of about 79 μm. In embodiments, the channel includes a depth of 50 μm to 150 μm. The depth of the channel may be referred to as the height of the channel or the distance between the first and second slides. In embodiments, the channel includes a depth of 50 μm. In embodiments, the channel includes a depth of 60 μm. In embodiments, the channel includes a depth of 70 μm. In embodiments, the channel includes a depth of 80 μm. In embodiments, the channel includes a depth of 90 μm. In embodiments, the channel includes a depth of 100 μm. In embodiments, the channel includes a depth of 110 μm. In embodiments, the channel includes a depth of 120 μm. In embodiments, the channel includes a depth of 130 μm. In embodiments, the channel includes a depth of 140 μm. In embodiments, the channel includes a depth of 150 μm. In embodiments, the channel includes a depth of 160 μm. In embodiments, the channel includes a depth of 170 μm. In embodiments, the channel includes a depth of 180 μm. In embodiments, the channel includes a depth of 190 μm. In embodiments, the channel includes a depth of 200 μm.

In embodiments, the first slide or the second slide includes a port. In embodiments, the first slide or the second slide includes an inlet port and an outlet port. In embodiments, the first slide includes an inlet port and an outlet port. In embodiments, the second slide includes an inlet port and an outlet port. In embodiments, the first slide includes an inlet port. In embodiments, the second slide includes an inlet port. In embodiments, the first slide includes an outlet port. In embodiments, the second slide includes an outlet port. In embodiments, each port is about 0.50 to about 1.00 mm in diameter. In embodiments, each port is 0.50 to 1.00 mm in diameter. In embodiments, each port is 0.7 to 0.8 mm in diameter. In embodiments, each port is 0.50, 0.55, 0.60, 0.65, 0.70, 0.75, 0.80, 0.85, 0.90, 0.95, or 1.00 mm in diameter. In embodiments, each port is 70, 75, or 80 mm in diameter. In embodiments, each port is about 50 to about 100 mm in diameter. In embodiments, each port is 50 to 100 mm in diameter. In embodiments, each port is 50, 55, 60, 65, 70, 75, 80, 85, 90, 95, or 100 mm in diameter. In embodiments, each port is 70, 75, or 80 mm in diameter.

In embodiments, the first slide includes a pressure sensitive adhesive (PSA) attached to a glass slide, wherein the glass slide includes inlet and outlet ports. In embodiments, first slide includes a pressure sensitive adhesive (PSA) laminated to a glass slide, wherein the glass slide includes inlet and outlet ports. In embodiments, the second slide includes a pressure sensitive adhesive (PSA) attached to a glass slide, wherein the glass slide includes inlet and outlet ports. In embodiments, second slide includes a pressure sensitive adhesive (PSA) laminated to a glass slide, wherein the glass slide includes inlet and outlet ports. In embodiments, the pressure sensitive adhesive has a thickness of about 10 μm to about 100 μm. In embodiments, the pressure sensitive adhesive has a thickness of about 70 μm to about 100 μm. In embodiments, the pressure sensitive adhesive has a thickness of about 100 μm to about 200 μm. In embodiments, the pressure sensitive adhesive has a thickness of about 200 μm to about 500 μm. In embodiments, the pressure sensitive adhesive has a thickness of about 10 μm, 11 μm, 12 μm, 13 μm, 14 μm, 15 μm, 16 μm, 17 μm, 18 μm, 19 μm, 20 μm, 21 μm, 22 μm, 23 μm, 24 μm, 25 μm, 26 μm, 27 μm, 28 μm, 29 μm, 30 μm, 31 μm, 32 μm, 33 μm, 34 μm, 35 μm, 36 μm, 37 μm, 38 μm, 39 μm, 40 μm, 41 μm, 42 μm, 43 μm, 44 μm, 45 μm, 46 μm, 47 μm, 48 μm, 49 μm, 50 μm, 51 μm, 52 μm, 53 μm, 54 μm, 55 μm, 56 μm, 57 μm, 58 μm, 59 μm, 60 μm, 61 μm, 62 μm, 63 μm, 64 μm, 65 μm, 66 μm, 67 μm, 68 μm, 69 μm, 70 μm, 71 μm, 72 μm, 73 μm, 74 μm, 75 μm, 76 μm, 77 μm, 78 μm, 79 μm, 80 μm, 81 μm, 82 μm, 83 μm, 84 μm, 85 μm, 86 μm, 87 μm, 88 μm, 89 μm, 90 μm, 91 μm, 92 μm, 93 μm, 94 μm, 95 μm, 96 μm, 97 μm, 98 μm, 99 μm, 100 μm, 101 μm, 102 μm, 103 μm, 104 μm, 105 μm, 106 μm, 107 μm, 108 μm, 109 μm, 110 μm, 111 μm, 112 μm, 113 μm, 114 μm, 115 μm, 116 μm, 117 μm, 118 μm, 119 μm, 120 μm, 121 μm, 122 μm, 123 μm, 124 μm, 125 μm, 126 μm, 127 μm, 128 μm, 129 μm, 130 μm, 131 μm, 132 μm, 133 μm, 134 μm, 135 μm, 136 μm, 137 μm, 138 μm, 139 μm, 140 μm, 141 μm, 142 μm, 143 μm, 144 μm, 145 μm, 146 μm, 147 μm, 148 μm, 149 μm, 150 μm or greater. In embodiments, the pressure sensitive adhesive has a thickness of about 50 μm, 55 μm, 60 μm, 65 μm, 70 μm, 75 μm, 80 μm, 85 μm, 90 μm, 95 μm, 100 μm, 105 μm, 110 μm, 115 μm, 120 μm, 125 μm, 130 μm, 135 μm, 140 μm, 145 μm, 150 μm, 155 μm, 160 μm, 165 μm, 170 μm, 175 μm, 180 μm, 185 μm, 190 μm, 195 μm, 200 μm, 205 μm, 210 μm, 215 μm, 220 μm, 225 μm, 230 μm, 235 μm, 240 μm, 245 μm, 250 μm, or greater.

In embodiments, the pressure sensitive adhesive (PSA) includes to a first adhesive attached to a carrier polymer, where the carrier polymer is further attached to a second adhesive. In embodiments, the carrier polymer is between the first adhesive and the second adhesive. In embodiments, the adhesive includes an acrylic material. In embodiments, the adhesive includes rubber. In embodiments, the adhesive includes silicone. In embodiments, a variety of adhesive materials are utilized for fabricating leak-free chambers in a flow cell, each selected based on their unique properties and the specific requirements of the application. Acrylic-based adhesives are favored for their strong bond and resistance to environmental factors, while rubber-based adhesives are chosen for their flexibility and resilience in applications requiring movement. Silicone adhesives are notable for their high-temperature resistance and moisture-proof sealing capabilities. Epoxy resins offer unparalleled strength and chemical resistance, making them ideal for demanding industrial applications. Polyurethane adhesives, known for their balance of strength, flexibility, and chemical resistance, are versatile in bonding diverse materials. Lastly, cyanoacrylates, are valued for their rapid setting and strong bonding properties, essential for quick and reliable leak prevention.

In embodiments, the first slide includes a plurality of channels etched in glass that is capable of being in contact with a UV-curable adhesive. In embodiments, the second slide includes a plurality of channels etched in glass that is capable of being in contact with a UV-curable adhesive. A UV-curable adhesive is an adhesive that hardens or sets when exposed to ultraviolet light. In embodiments, the UV-curing adhesive cures when exposed to wavelengths about 365 nm to about 405 nm. In embodiments, the UV-curing adhesive cures when exposed to wavelength of about 405 nm. In embodiments, the UV-curable adhesive is chemically compatible with glass. The UV-curing adhesive includes a mixture of photo-initiator that, upon exposure to UV light, initiates a polymerization reaction that converts the liquid adhesive into a solid polymer, resulting in a rapid curing process. In embodiments, use of a UV-curing adhesive on the first slide provides channel depth consistency and a leak-free seal. In embodiments, use of a UV-curing adhesive on the second slide provides channel depth consistency and a leak-free seal.

In embodiments, the first slide is a tissue slide and includes one or more tissue sections immobilized thereto. In embodiments, the tissue includes a thickness of about 1 μm to about 20 μm. In embodiments, the tissue includes a thickness of about 1 μm to about 10 μm. In embodiments, the tissue includes a thickness of about 2 μm to about 3 μm. In embodiments, the tissue includes a thickness of about 4 μm to about 6 μm. In embodiments, the tissue includes a thickness of about 4 μm. In embodiments, the tissue includes a thickness of about 5 μm. In embodiments, the tissue includes a thickness of about 6 μm. In embodiments, the tissue includes a thickness of about 7 μm. In embodiments, the tissue includes a thickness of about 8 μm. In embodiments, the tissue includes a thickness of about 9 μm. In embodiments, the tissue includes a thickness of about 10 μm.

In embodiments, the tissue section includes a tissue or a cell (e.g., a plurality of cells such as blood cells). In embodiments, the tissue section includes one or more cells. In embodiments, the tissue section is embedded in an embedding material including paraffin wax, polyepoxide polymer, polyacrylic polymer, agar, gelatin, celloidin, cryogel, optimal cutting temperature (OCT) compositions, glycols, or a combination thereof. In embodiments, the tissue section is embedded in an embedding material including paraffin wax. In embodiments, the tissue section is embedded in an embedding material including a polyepoxide polymer. In embodiments, the tissue section is embedded in an embedding material including polyacrylic polymer. In embodiments, the tissue section is embedded in an embedding material including agar. In embodiments, the tissue section is embedded in an embedding material including gelatin. In embodiments, the tissue section is embedded in an embedding material including celloidin. In embodiments, the tissue section is embedded in an embedding material including a cryogel. In embodiments, the tissue section is embedded in an embedding material including an optimal cutting temperature (OCT) compositions. In embodiments, the tissue section is embedded in an embedding material including one or more glycols. Tissue sections may be obtained from a subject by any means known and available in the art. In particular embodiments, a tissue section, e.g., a tumor tissue sample, is obtained from a subject by fine needle aspiration, core needle biopsy, stereotactic core needle biopsy, vacuum-assisted core biopsy, or surgical biopsy. In particular embodiments, the surgical biopsy is an incisional biopsy, which removes only part of the suspicious area. In embodiments, the first slide is a tissue slide and the one or more tissue sections immobilized thereto comprise at least one of fresh tissue, fresh-frozen tissue, fixed tissue, formalin-fixed paraffin-embedded (FFPE) tissue, decalcified tissue, or cryosectioned tissue. In embodiments, the one or more tissue sections are immobilized to the first slide by at least one of electrostatic attraction, adsorption, covalent attachment, affinity binding, or a coating-mediated bond. In embodiments, the first slide comprises a tissue-adhesive surface including at least one of a charged surface, a silane-treated surface, a poly-L-lysine coating, an aminosilane coating, an epoxy coating, an aldehyde coating, or a combination thereof, thereby immobilizing the one or more tissue sections to the first slide. In embodiments, the tissue slide includes from 1 to 50 tissue sections immobilized thereto. In embodiments, each tissue section has a thickness from about 1 μm to about 50 μm. In embodiments, each tissue section has an areal footprint from about 1 mm² to about 1,000 mm². In embodiments, adjacent tissue sections are separated by a spacing from about 0.1 mm to about 10 mm.

In embodiments, the rollers are designed to exert a compressive force of approximately 20 lbs as the flow cell passes through the roller assembly. In embodiments, the rollers are designed to exert a compressive force of approximately 14.5-15 lbs as the flow cell passes through the roller assembly. This force is selected to activate the pressure-sensitive adhesive used to bond the first and second flow cell components while maintaining structural integrity. The force level is determined based on a safety factor derived from experimental observations, which indicate that two-lane flow cells may fracture when subjected to excessive forces, for example greater than 70 lbs. In embodiments, the first roller and the second roller compress the flow cell to apply about a 20 pound force to the flow cell. In embodiments, the first roller 130a and the second roller 130b compress the flow cell 112 to apply a force in the range of 15 to 25 pounds. In embodiments, the rollers are configured to exert a compressive force of about 10 lbs to about 40 lbs as the flow cell passes through the roller assembly. In embodiments, the rollers are configured to exert a compressive force of about 12 lbs to about 25 lbs as the flow cell passes through the roller assembly. In embodiments, the rollers are configured to exert a compressive force of about 14.5 lbs to about 15.5 lbs as the flow cell passes through the roller assembly. In embodiments, the first roller and the second roller compress the flow cell to apply a compressive force of about 20 lbs to the flow cell. In embodiments, the first roller and the second roller compress the flow cell to apply a compressive force in a range of about 15 lbs to about 25 lbs to the flow cell. In embodiments, the compressive force is selected to activate a pressure-sensitive adhesive disposed between the first flow cell component and the second flow cell component to thereby bond the first flow cell component to the second flow cell component. In embodiments, the compressive force is selected to activate the pressure-sensitive adhesive while maintaining structural integrity of the flow cell by limiting a peak applied force below a fracture threshold of the flow cell. In embodiments, experimental observation indicates that a two-lane flow cell fractures when subjected to a compressive force greater than about 70 lbs, and the rollers are configured to apply a compressive force that is less than the fracture threshold by a safety factor of at least about 2.0, at least about 3.0, or about 3.5. In embodiments, the roller assembly includes a compliance mechanism configured to distribute the compressive force substantially uniformly across a width of the flow cell to reduce localized stress concentrations. In embodiments, the roller assembly is configured to apply the compressive force as a substantially constant-force profile, a constant-gap profile, a constant-deflection profile, or a combination thereof as the flow cell passes through the roller assembly. n embodiments, the roller assembly includes a force-limiting feature comprising at least one of a mechanical stop, a spring bias, a torque limiter, or a motor current limit configured to prevent application of compressive force exceeding a predefined threshold. In embodiments, the roller assembly actuator is configured to adjust at least one of roller speed, commanded force, commanded gap, or dwell time based on a flow cell format comprising a two-lane flow cell or a four-lane flow cell.

In embodiments, the rollers are composed of urethane with an 80 A durometer rating, which provides an optimal balance between firmness and compliance. Urethane is selected for its durability, wear resistance, and ability to maintain structural integrity over repeated compression cycles. Alternative roller compositions may include silicone, nitrile rubber, or thermoplastic elastomers (TPEs), depending on the specific requirements of the bonding process. In embodiments, the surface texture of the rollers may be engineered to enhance grip and reduce slippage as the flow cell moves through the roller assembly. The rollers may include a smooth surface finish for uniform pressure distribution, or they may incorporate a finely textured or patterned surface to improve traction. Additional surface coatings, such as anti-static treatments, hydrophobic coatings, or low-friction finishes, may be applied to optimize performance based on environmental and operational factors. In embodiments, the roller assembly may incorporate a preloading mechanism that provides consistent pressure application regardless of minor variations in flow cell thickness. This mechanism may include tension springs, torsion springs, pneumatic actuators, and/or hydraulic dampers, which dynamically adjust the roller position to maintain the desired compressive force. Such configurations allow the system to accommodate flow cells with slight dimensional tolerances while providing reliable adhesion activation.

In embodiments, the rollers comprise urethane having a Shore A durometer from about 60 A to about 95 A. In embodiments, the rollers comprise urethane having a Shore A durometer from about 70 A to about 90 A. In embodiments, the rollers comprise urethane having a Shore A durometer of about 80 A. In embodiments, the rollers comprise an elastomer selected from urethane, silicone, nitrile rubber, EPDM, fluorosilicone, and thermoplastic elastomers (TPEs), or a combination thereof. In embodiments, each roller comprises a rigid core and an elastomeric outer layer disposed on the rigid core. In embodiments, the rigid core comprises aluminum, stainless steel, polymer, or fiber-reinforced composite. In embodiments, the rollers are configured to maintain dimensional stability and wear resistance over repeated compression cycles of at least about 1,000 cycles, at least about 10,000 cycles, or at least about 100,000 cycles. In embodiments, a roller surface has a surface roughness (Ra) from about 0.1 μm to about 10 μm. In embodiments, the roller surface comprises a smooth finish configured to promote uniform pressure distribution across the flow cell. In embodiments, the roller surface comprises a textured, knurled, or patterned finish configured to increase traction and reduce slippage during conveyance of the flow cell. In embodiments, the roller surface includes a pattern comprising ribs, grooves, dimples, or a microtextured pattern. In embodiments, the rollers include a surface coating comprising an anti-static coating, a hydrophobic coating, an oleophobic coating, a low-friction coating, a wear-resistant overcoat, or a combination thereof. In embodiments, the rollers include an anti-static additive and/or a conductive filler configured to reduce electrostatic charge accumulation during operation. In embodiments, the roller assembly includes a preloading mechanism configured to provide a substantially constant compressive force despite thickness variation of the flow cell. In embodiments, the preloading mechanism comprises at least one of a tension spring, a compression spring, a torsion spring, a constant-force spring, or a Belleville washer stack. In embodiments, the preloading mechanism comprises at least one of a pneumatic actuator, a hydraulic actuator, or a gas spring configured to bias the rollers toward a target nip force. In embodiments, the roller assembly includes a damper comprising a hydraulic damper, an elastomer damper, or a friction damper configured to reduce force spikes during entry of the flow cell into a roller nip. In embodiments, the roller assembly includes an adjustment mechanism comprising a lead screw, cam, eccentric, shim, or spacer configured to set a roller gap and/or preload level. In embodiments, the roller assembly is configured to accommodate a thickness tolerance of the flow cell of at least about ±0.01 mm, at least about ±0.05 mm, or at least about ±0.2 mm while maintaining the desired compressive force. In embodiments, the preloading mechanism dynamically adjusts roller position to maintain the desired compressive force as the flow cell advances through the roller assembly. In embodiments, the roller assembly includes a force-limiting feature comprising at least one of a mechanical stop, a torque limiter, or a motor current limit configured to prevent compressive loading beyond a predefined threshold.

In embodiments, the output tray actuator is a lever. In embodiments, the output tray actuator 120 is a lever extending outwardly from the outer housing 105. In embodiments, the lever is mechanically coupled to the output tray 115, allowing for movement between a first, receiving position and a second, releasing position. In embodiments, the lever is positioned to enable user access and engagement. In embodiments, the lever includes a grip surface that may feature texturing or contouring. The guide slot 140 defines a movement path that may be linear, arced, or curvilinear, influencing the travel of the output tray 115. The output tray 115 tilts as it moves along the guide slot 140, aligning with an external access point of the housing 105. In embodiments, the lever is configured with spring-loading, allowing the output tray 115 to return to its default position when not engaged. The lever may be constructed from metal, reinforced polymer, or composite materials. Alternative implementations include adjustable resistance mechanisms, such as dampers or friction-based pivot points.

In embodiments, the output tray actuator is a lever extending outwardly from an outer housing. In embodiments, the lever is positioned on a front face, side face, or top face of the housing to enable user access and engagement. In embodiments, the lever includes a grip surface comprising texturing, contouring, an elastomer overmold, or a combination thereof. In embodiments, the lever is pivotably coupled to the housing about a pivot axis and is mechanically linked to the output tray via a linkage comprising a pin, a cam, a follower, a rack feature, or a combination thereof. In embodiments, the lever translates the output tray along a guide slot defining a movement path that is linear, arced, curvilinear, or a combination thereof. In embodiments, the guide slot defines a detent position corresponding to the first position and/or the second position. In embodiments, the output tray tilts as it moves along the guide slot to align the flow cell with an access opening of the housing. In embodiments, the output tray is configured to rotate about a hinge axis while translating along the guide slot to provide combined tilt-and-translate motion. In embodiments, the lever provides a mechanical advantage configured to reduce user actuation force below about 1 lbf, below about 3 lbf, or below about 5 lbf. In embodiments, the lever includes an adjustable stop configured to set a travel distance and/or a release angle of the output tray. In embodiments, the lever includes spring-loading to bias the output tray toward a default position when the lever is not engaged. In embodiments, the spring-loading comprises a torsion spring, extension spring, compression spring, constant-force spring, or a combination thereof. In embodiments, the output tray actuator includes a latch configured to retain the output tray in the second position until user release. In embodiments, the output tray actuator includes a damper configured to control a speed of movement of the output tray to reduce abrupt motion. In embodiments, the damper comprises a hydraulic damper, rotary damper, elastomer damper, or friction damper. In embodiments, the lever includes an adjustable resistance mechanism comprising a friction-based pivot, a friction pad, a viscous damper, or a combination thereof. In embodiments, the lever is constructed from metal, reinforced polymer, composite material, or a combination thereof. In embodiments, the lever comprises stainless steel, aluminum, glass-filled nylon, polycarbonate, acetal, or a combination thereof. In embodiments, the guide slot comprises a low-friction insert and/or wear strip comprising PTFE, UHMWPE, acetal, or a combination thereof. In embodiments, the lever is configured for single-handed operation and includes a pinch-point guard configured to reduce user contact with moving interfaces. In embodiments, the output tray actuator comprises a knob, slider, push-button, foot pedal, rotary dial, or motorized actuator in place of, or in addition to, the lever.

In embodiments, the motorized actuator comprises a linear actuator, stepper motor, servo motor, or solenoid configured to actuate the output tray between the first position and the second position.

In embodiments, the output tray actuator is movably positioned through a guide slot in a side of the outer housing and wherein the output tray actuator slides along the guide slot to cause the output tray to move between the first position and the second position. In embodiments, the output tray actuator 120 is movably positioned through a guide slot 140 in a side of the outer housing 105. The output tray actuator 120 is configured to slide along the guide slot 140, directing the movement of the output tray 115 between the first, receiving position and the second, releasing position. In embodiments, the guide slot 140 defines a controlled movement path, enabling repeatable positioning of the output tray 115. The shape of the guide slot 140 may be linear, arced, or curvilinear, influencing the motion characteristics of the output tray 115. An arced guide slot causes the output tray 115 to tilt as it moves into the second position, positioning the bonded flow cell 112 for retrieval. In embodiments, the output tray actuator 120 extends outwardly through the guide slot 140 for manual engagement. The actuator 120 may be configured with a lever, pin, or tab to facilitate user interaction. The fit between the actuator and the guide slot may be precision-machined or tolerance-controlled to maintain stability during operation. In embodiments, the output tray actuator 120 is biased by a spring mechanism, returning the output tray 115 to the first position when the actuator is released. The spring force is calibrated to prevent unintentional movement while allowing smooth actuation. Alternative configurations may incorporate adjustable resistance elements, such as dampers or friction-based pivots, to modify the motion dynamics of the output tray 115.

In embodiments, the roller assembly actuator is a rotatable crank. In embodiments, the rotatable crank is mechanically coupled to a roller shaft of at least one of the rollers such that rotation of the crank causes the roller shaft to rotate. In embodiments, the roller assembly actuator 135 is a rotatable crank positioned on the outer housing 105. The crank may extend outwardly for user access and is configured to drive the roller assembly 125 during operation. In embodiments, the rotatable crank is mechanically coupled to a roller shaft of at least one of the rollers 130a, 130b. Rotation of the crank 135 transmits torque to the roller shaft, causing the rollers 130a, 130b to rotate and advance the flow cell 112 from the input tray 110 to the output tray 115. In embodiments, the mechanical coupling between the crank 135 and the roller shaft may include a direct drive connection, a gear assembly, or a belt-and-pulley system. The coupling mechanism is designed to maintain consistent rotational force, providing uniform compression of the flow cell 112 as it passes through the rollers 130a, 130b. In embodiments, the crank 135 may feature an ergonomic grip, a textured surface, or a foldable design to enhance usability. The crank 135 may be dimensioned to provide sufficient mechanical advantage, reducing the effort required to rotate the rollers 130a, 130b while maintaining control over the rolling process. In embodiments, alternative actuation mechanisms, such as a motorized drive system or an automated servo-controlled actuator, may be implemented to replace or supplement the manual crank 135 for enhanced precision and repeatability.

In embodiments, the input tray is fixedly positioned on the housing such that the input tray can receive the flow cell from a user. In embodiments, the input tray is positioned to slidingly guide the flow cell toward the roller assembly. In embodiments, the input tray is positioned to slidingly guide the flow cell toward the output tray when the output tray is in the first position. In embodiments, the input tray extends outward from a top of the outer housing.

In embodiments, the input tray 110 is fixedly positioned on the outer housing 105, providing a stable platform for receiving the flow cell 112 from a user. The fixed positioning may prevent unintended movement of the input tray 110, maintaining alignment with the roller assembly 125 and ensuring consistent flow cell processing. In embodiments, the input tray 110 is configured to slidingly guide the flow cell 112 toward the roller assembly 125, facilitating smooth and controlled entry into the compression zone. The tray's surface may be low-friction or coated with anti-static materials (e.g., PTFE (polytetrafluoroethylene), PFA (perfluoroalkoxy), FEP (fluorinated ethylene propylene), UHMW polyethylene (ultra-high-molecular-weight polyethylene), acetal (POM), nylon, graphite-impregnated polymers, anodized aluminum with Teflon coating, silicone-based coatings, carbon-loaded polymers, anti-static polyurethane, ESD-safe acrylic, stainless steel with DLC (diamond-like carbon) coating, ceramic-coated surfaces) to minimize resistance and enable movement of the flow cell 112. In embodiments, the input tray 110 is aligned to direct the flow cell 112 toward the output tray 115 when the output tray 115 is in the first, receiving position. The alignment may provide a seamless transition from the input tray 110 through the roller assembly 125 to the output tray 115, reducing the likelihood of misalignment or jamming. In embodiments, the input tray 110 extends outward from a top portion of the outer housing 105, allowing convenient user access for flow cell placement. The outward extension may be dimensioned to support proper flow cell positioning while maintaining a compact overall system footprint. The entry angle and positioning of the input tray 110 may be optimized for ergonomic handling and ease of insertion, enabling repeatable and controlled placement of the flow cell 112 into the system.

In embodiments, the output tray rotates between the first position and the second position. In embodiments, the output tray is aligned along a common axis with the input tray when the output tray is in the first position such that the flow cell can slide from the input tray into the output tray as a roller of the roller assembly rotates. In embodiments, the output tray is positioned to extend outwardly through a window in the outer housing when the output tray is in the second position such that a user can remove the flow cell from the output tray after the flow cell has been transferred from the input tray to the output tray. In embodiments, the output tray 115 is configured to rotate between the first, receiving position and the second, releasing position. The rotational movement is controlled by the output tray actuator 120, which moves along a guide slot 140 to transition the tray between these positions. The rotational mechanism may include a pivoting hinge, a linkage assembly, or a cam-based system, allowing for smooth and repeatable operation. In embodiments, the output tray 115 is aligned along a common axis with the input tray 110 when in the first position, allowing the flow cell 112 to slide seamlessly from the input tray 110 into the output tray 115 as at least one roller 130 of the roller assembly 125 rotates. The alignment between the input tray 110 and the output tray 115 aids in controlled movement of the flow cell 112, preventing misalignment, jamming, or unintended rotation of the flow cell during processing. In embodiments, the output tray 115 extends outwardly through a window 145 in the outer housing 105 when in the second position, providing user access to the bonded flow cell 112. The size and shape of the window 145 may be configured to facilitate easy retrieval while maintaining the structural integrity of the housing 105. The window 145 may also incorporate a dust cover, a retractable door, or an optical sensor to enhance usability and ensure process control. In embodiments, the rotational motion of the output tray 115 may be assisted by spring-loaded hinges, dampers, or friction-based pivots, enabling smooth operation and controlled movement. The rotational force may be adjusted based on tray weight, material selection, or user handling preferences, optimizing ease of use while maintaining alignment and repeatability.

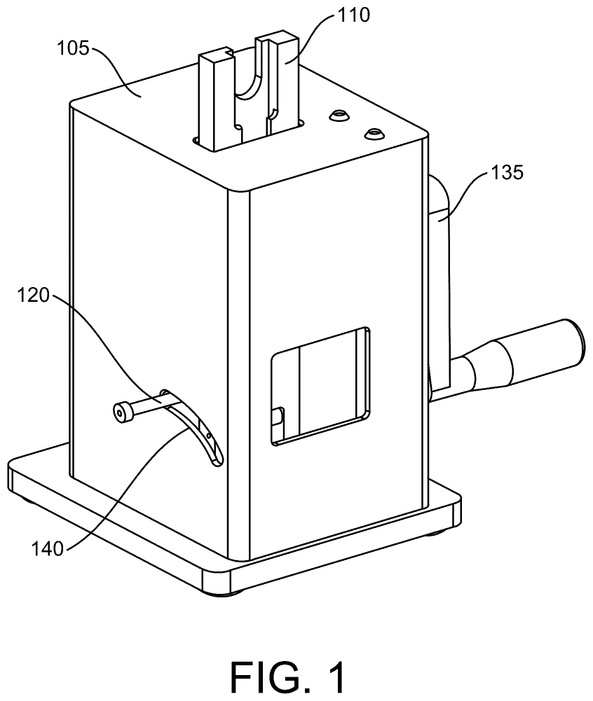

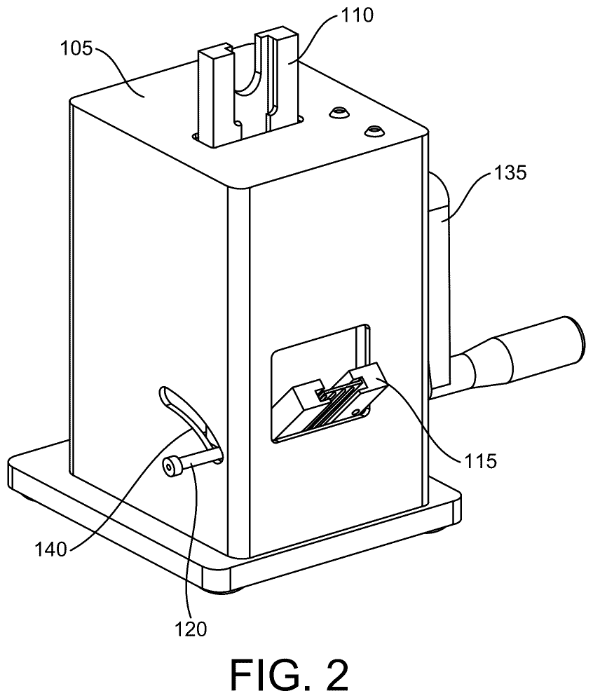

FIGS. 1 and 2 shows perspective views of first implementation of an assembly or system configured to apply pressure to a flow cell 112 formed of at least a first flow cell component and a second flow cell component. The applies pressure sealingly attaches the flow cell components to one another in a juxtaposed relationship. The first flow cell component can be a glass slide component (such as a planar body) and the second flow cell component can be a tissue slide component (such as a planar body) juxtaposed with the glass slide component. The input tray 110 and the output tray 115 are frames that are sized and shaped to slidingly receive the flow cell 112.

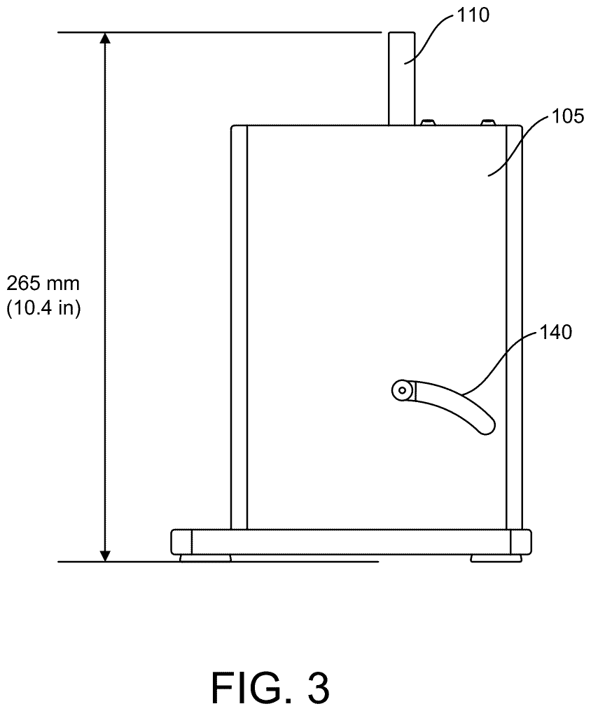

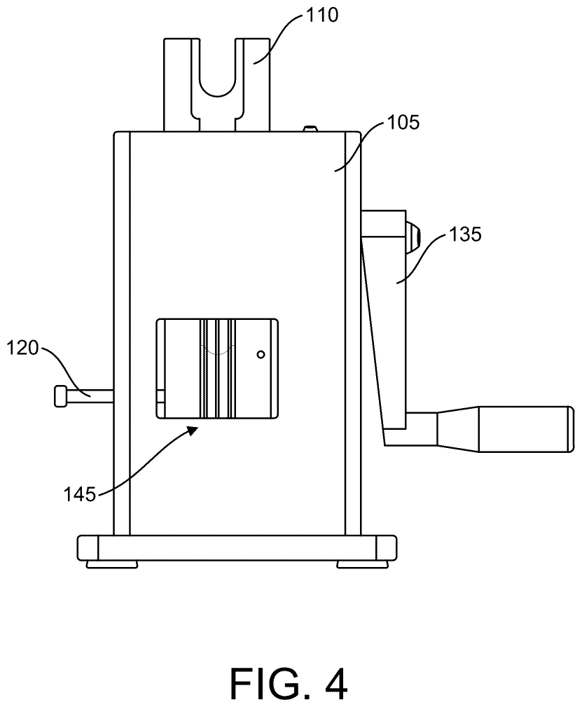

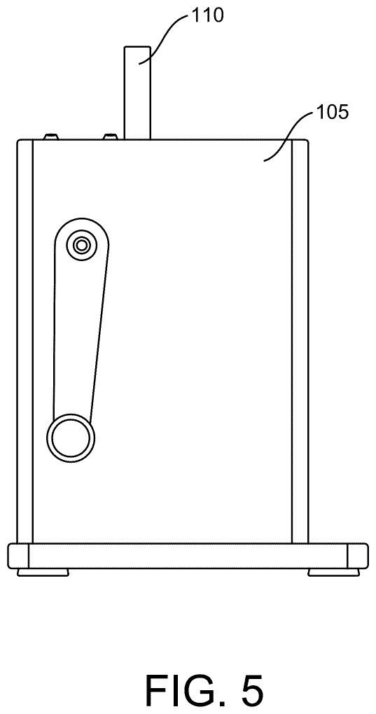

FIGS. 3 and 5 show side views of the system while FIG. 4 shows a front view of the system. The system includes an outer housing 105 that is coupled to an input tray 110 and an output tray 115 (FIG. 2). The input tray 110 is configured to slidingly receive the flow cell 112. The input tray 110 positions the flow cell 112 such that it can be passed into and compressed by an internal roller assembly, which passes the flow cell 112 to the output tray 115 for receipt by a user. FIGS. 1 and 2 show the outer housing as having a prismatic shape although the shape of the outer housing can vary.

With reference to FIGS. 1-5, an output tray actuator 120 extends outwardly from the housing 105. A user can actuate the output tray actuator 120 to move the output tray between a first position (shown in FIG. 1) configured to receive the flow cell 112 from the input tray 110 and a second position (shown in FIG. 2) configured to position the flow cell 112 for release from the outer housing, as described more fully below.

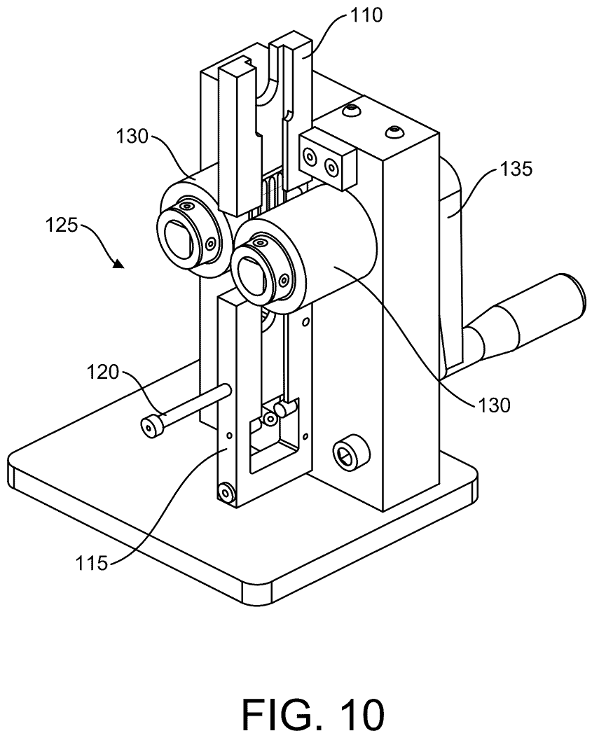

The roller assembly 125 (FIG. 10) is positioned inside the outer housing 105. As described more fully below, the roller assembly 125 includes at least one roller 130 configured to apply pressure to compress the first flow cell component and the second flow cell component as the flow cell passes from the input tray 110 to the output tray 115. The roller assembly 125 is mechanically coupled to a roller assembly actuator 135 that is actuated to cause at least one roller of the roller assembly to rotate and drive the flow cell toward the output tray 115 from the input tray. In a non-limiting example implementation, the roller assembly actuator 135 is a crank that a user rotates to cause the at least one roller of the roller assembly to rotate. A shown in FIGS. 1-5, the roller assembly actuator 135 extends outwardly from a side of the housing for access by a user.

With reference to FIGS. 1, 2, and 3, the output tray actuator 120 extends outwardly through a guide slot 140 in a side of the outer housing 105. The output tray actuator 120 can be for example a lever or pin that slides along the guide slot to cause the output tray 115 to move between the first, receiving position and the second, releasing position. The guide slot 140 can define various shaped pathways sliding movement of the output tray actuator 120 including a straight, curved, or curvilinear pathway. In an implementation, the guide slot 140 is arced such that the output tray tilts 115 into the second position from the first position as the output tray actuator 120 slides along the guide slot 140.

FIG. 10 shows the system with the outer housing removed to show inner components. FIG. 10 shows the output tray 115 in the first, receiving position. When in the first, receiving position, the output tray 115 is aligned along a common axis and/or common plane with the input tray 110. In this manner, the flow cell 112 can slide from the input tray 110 into the output tray 115 as a roller of the roller assembly 125 rotates due to actuation of the roller assembly actuator 135. Once the flow cell 112 is positioned in the output tray 115, a user can actuate the output tray actuator 120 by sliding the output tray actuator 120 along the guide slot 140 to move the output tray 115 to the second, release position as shown in FIG. 2. The output tray 115 can be accessed and/or extend outwardly through a window 145 in the outer housing 105 when in the second, receiving position as shown in FIG. 2.

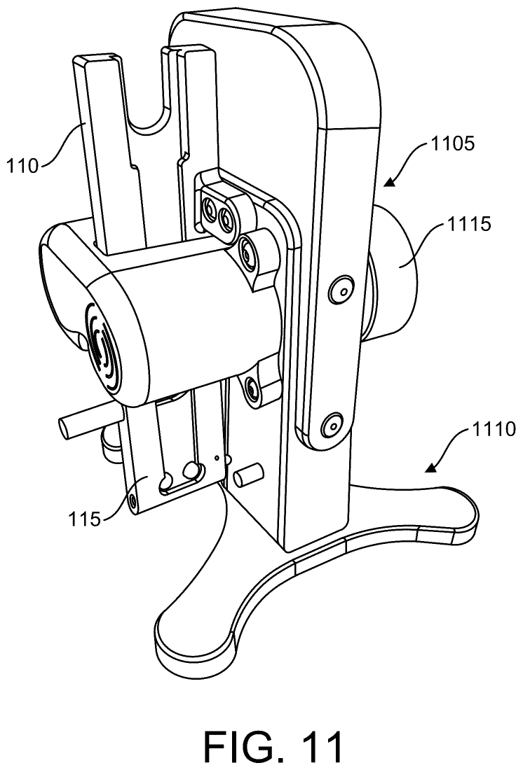

FIG. 11 shows another implementation of the system that does not include an outer housing. The system of FIG. 10 includes a frame 1105 having a base 1110 that can be placed on a surface to support the frame 1105 in an upright position. In an example implementation, the base 1110 is forms of one or more legs. The structural configuration of the frame 1105 can vary in shape and size. In an implementation, the frame is at least partially contained within an outer housing. The input tray 110 is coupled to the frame 1105 in an upward or vertically oriented position such that the input tray 110 can slidingly receive the flow cell 112. The output tray 115 is aligned in position with the input tray 110 to slidingly receive the flow cell 112 as described above.

The system includes a roller assembly (such as inside a portion of the frame 1105), wherein the roller assembly can be actuated by a roller assembly actuator formed of a rotatable knob 1115 (rather than a handle as in the prior embodiment) coupled to the frame 1105. The structure of the roller assembly actuator can vary and is not limited to a knob. As described in more detail below, the knob 1115 can be rotated to slide the flow cell 112 positioned in the input tray 110 into the output tray 115 as a roller of the roller assembly rotates due to actuation of the knob 1115. The output tray can have a rubber bumper on a bottom surface to soften forces as the flow cell exits the roller assembly and enters the output tray.

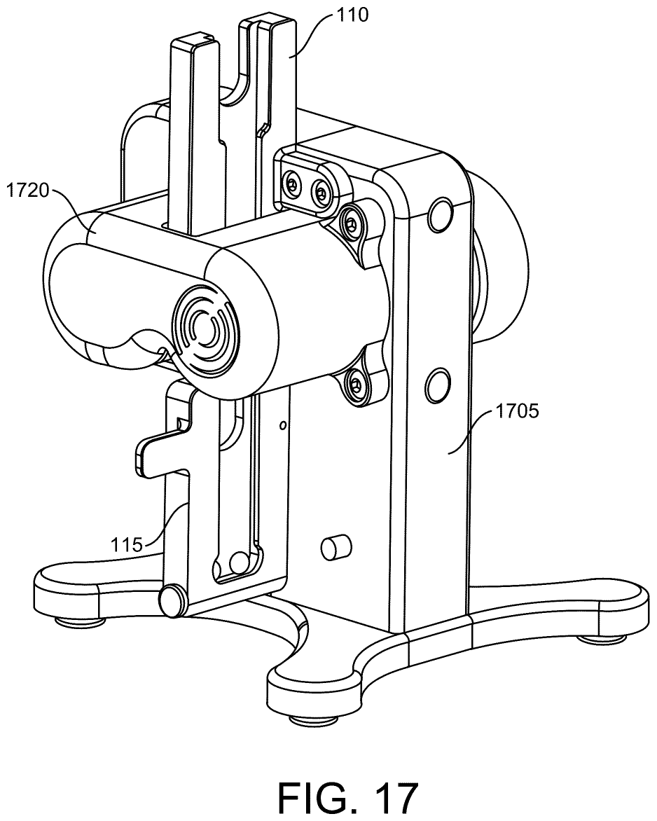

FIG. 17 shows another implementation of the system. The system of FIG. 17 includes a frame 1705 having a multi-legged base 1110 that can be placed on a surface to support the frame 1705 in an upright position. The base 1110 is forms of one or more legs that sprawl outward for supporting the frame upright. The structural configuration of the frame 1705 can vary in shape and size. In an optional implementation, the frame is at least partially contained within an outer housing. The input tray 110 is coupled to the frame 1705 in an upward or vertically oriented position such that the input tray 110 can slidingly receive the flow cell 112. The output tray 115 is aligned in position with the input tray 110 to slidingly receive the flow cell 112 as described above. The input tray 110 and the output tray 115 are positioned within a rounded housing 1720 that may vary in shape. The housing 1720 can stabilize the input tray 110 and the output tray 115 in relative positions.

In another aspect is provided a kit for forming a flow cell, the kit including: a roller press system as described herein; and one or more flow cell components including a first slide and a second slide configured to be bonded together to define a reaction chamber. In embodiments, the one or more flow cell components include an adhesive disposed on the second slide, wherein the adhesive includes a pressure-sensitive adhesive configured to bond the first slide to the second slide upon application of compressive force by the roller press system. In embodiments, the first slide includes an inlet port configured to fluidically couple to the reaction chamber when the first slide is bonded to the second slide. In embodiments, the kit further includes one or more alignment features including an alignment fixture, guide rails, edge stops, pins, or datum surfaces configured to align the first slide relative to the second slide prior to bonding. In embodiments, the kit further includes one or more spacers or shims including gauge inserts configured to set a roller gap and/or a chamber height of the reaction chamber. In embodiments, the kit further includes instructions for use including instructions to: insert an unbonded flow cell into an input tray of the roller press system; actuate a roller assembly actuator to advance the unbonded flow cell through a roller nip to activate the adhesive; and actuate an output tray actuator to present the bonded flow cell for removal. In embodiments, the kit further includes one or more reagents including antibodies, oligonucleotides, buffers, wash solutions, and/or amplification reagents configured for downstream processing of immobilized tissue within the reaction chamber after bonding. In embodiments, the kit further includes at least one accessory including tubing, a fitting, a gasket, a manifold interface, and/or a cap configured to couple to the inlet port for introducing reagents into the reaction chamber. In embodiments, the kit includes a plurality of flow cell formats including a two-lane flow cell format and a four-lane flow cell format. In embodiments, the kit includes packaging including a sterile pouch, a dust-protective container, and/or a humidity barrier configured to maintain cleanliness of the slides and adhesive prior to use.

### III. Methods

In an aspect is provided a method of using the system as described herein, including: slidingly inserting the flow cell into the input tray; rotating the roller assembly actuator such that the flow cell slides into the roller assembly and a first roller and a second roller compresses the flow cell therebetween; further rotating the roller assembly actuator so that the roller assembly drives the flow cell into the output tray while the output tray is in the first position; and actuating the output tray actuator to cause the output tray to move from the first position to the second position.

In embodiments, in another aspect is provided a roller assembly for bonding slides together to form a flow cell, the roller assembly including: a first roller and a second roller defining a nip therebetween; a mechanism configured to bias at least one of the first roller or the second roller toward the nip; and an actuator operably coupled to at least one of the first roller or the second roller, the actuator configured to rotate the at least one roller to advance a flow cell through the nip while applying a compressive load sufficient to activate a pressure-sensitive adhesive disposed between a first slide and a second slide of the flow cell. In embodiments, the mechanism includes at least one of: a compression spring, an extension spring, a torsion spring, a constant-force spring, a Belleville washer stack, an elastomeric mount, a flexure member, a pneumatic cylinder, a gas spring, a hydraulic cylinder, or a combination thereof, wherein the compliance mechanism is configured to accommodate thickness variation of the flow cell (e.g., 1-2 mm) while maintaining a target nip force. In embodiments, the compliance mechanism includes a spring-biased carriage supporting the first roller, wherein the spring-biased carriage is translatable along a direction normal to a flow direction of the flow cell to maintain contact between the first roller and the flow cell as the flow cell passes through the nip. In embodiments, the compliance mechanism includes a pneumatic actuator configured to apply a substantially constant nip force over a range of roller displacement, thereby reducing force variation attributable to dimensional tolerances of the flow cell. In embodiments, the compliance mechanism includes an elastomeric bushing or elastomeric coupling configured to damp force spikes during entry of the flow cell into the nip. In embodiments, the compliance mechanism further includes an adjustment mechanism configured to set a preload level and/or a nip gap, the adjustment mechanism including at least one of a lead screw, a cam, an eccentric, a shim, or a spacer. In embodiments, the actuator includes a manual actuator selected from a knob, crank, or lever, or a powered actuator selected from a stepper motor, DC motor, servo motor, or a combination thereof. In embodiments, the roller assembly further includes a force-limiting feature configured to limit a peak compressive load applied at the nip, the force-limiting feature including at least one of a mechanical stop, a torque limiter, a clutch, or a motor current limit. In embodiments, the compressive load applied at the nip is from about 10 pounds-force to about 40 pounds-force, from about 15 pounds-force to about 25 pounds-force, or about 20 pounds-force. In embodiments, at least one of the first roller or the second roller comprises an elastomeric roller surface configured to distribute load across a width of the flow cell, wherein the elastomeric roller surface comprises urethane, silicone, nitrile rubber, or a thermoplastic elastomer (TPE), and optionally has a Shore A durometer from about 60 A to about 95 A (e.g., about 80 A).

In embodiments, a method of using the system comprises slidingly inserting a flow cell into an input tray such that the flow cell is guided along a defined flow path toward a roller assembly. In embodiments, the method comprises actuating a roller assembly actuator to rotate at least one roller of the roller assembly to advance the flow cell from the input tray into a nip region between a first roller and a second roller. In embodiments, the method comprises compressing the flow cell between the first roller and the second roller to apply a compressive load configured to activate a pressure-sensitive adhesive disposed between a first flow cell component and a second flow cell component. In embodiments, the method comprises continuing to actuate the roller assembly actuator to drive the flow cell through the roller assembly and into an output tray while the output tray is in a first position configured to receive the flow cell. In embodiments, the method comprises actuating an output tray actuator to move the output tray from the first position to a second position configured to release the flow cell for removal from the system. In embodiments, the step of actuating the roller assembly actuator comprises manual rotation of a hand crank, lever-driven rotation, or motorized actuation. In embodiments, the step of actuating the roller assembly actuator comprises rotating the roller assembly actuator continuously, intermittently, or in a stepped manner. In embodiments, the method further comprises aligning the flow cell on the input tray using at least one alignment feature comprising rails, edge stops, pins, or datum surfaces prior to advancing the flow cell into the roller assembly. In embodiments, the method further comprises setting a roller gap and/or a preload level prior to advancing the flow cell into the roller assembly. In embodiments, the method further comprises applying compression for a dwell time from about 0.1 seconds to about 30 seconds (e.g., 1-5 seconds may be sufficient) while the flow cell is within, or immediately after exiting, the nip region. In embodiments, the method further comprises preventing overloading by limiting at least one of roller deflection, commanded gap, commanded force, actuator torque, or motor current during compression of the flow cell. In embodiments, the method further comprises reversing rotation of the roller assembly actuator to retract the flow cell in response to a jam condition or misalignment condition. In embodiments, the method further comprises removing the flow cell from the output tray when the output tray is in the second position.

In embodiments, the method includes immobilizing a plurality of tissue sections to the first slide, wherein a tissue in a plurality of tissue sections includes the biomolecule to be detected. In embodiments, the method includes immobilizing 2 tissue sections (10 mm×17 mm sections). In embodiments, the method includes immobilizing 4 tissue sections (10 mm×17 mm sections). In embodiments, the method includes immobilizing 6 tissue sections (10 mm×17 mm sections). In embodiments, the method includes immobilizing 24 tissue sections (10 mm×17 mm sections). In embodiments, the method includes immobilizing 8 tissue sections (10 mm×10 mm sections). In embodiments, the method includes immobilizing 10 tissue sections (10 mm×10 mm sections). In embodiments, the method includes immobilizing 12 tissue sections (10 mm×10 mm sections). In embodiments, the method includes immobilizing 16 tissue sections (10 mm×10 mm sections). In embodiments, the method includes immobilizing 20 tissue sections (10 mm×10 mm sections). In embodiments, the method includes immobilizing 40 tissue sections (10 mm×10 mm sections). In embodiments, the method includes immobilizing 2 to 32 tissue sections (4.5 mm×4.5 mm sections). In embodiments, the method includes immobilizing 32 tissue sections (4.5 mm×4.5 mm sections). In embodiments, the method includes immobilizing 128 tissue sections (4.5 mm×4.5 mm sections).

The cell or tissue may be manipulated prior to immobilizing the cell or tissue onto a slide using known techniques in the art (see, e.g., PCT Publication WO2023076832A1). In embodiments, the method further includes cutting a sample portion from the biological sample (e.g., including cells or tissues) using a punch device such that the punch device contains the sample portion; mounting the punch device containing the sample portion onto the first slide as described herein (e.g., inverting the punch device); pushing the sample portion out of the punch device using a piston, so that all or a portion thereof of the sample portion is positioned on the first slide as described herein. In embodiments, the method further includes cutting a sample portion from the biological sample using two or more punch devices such that each punch device contains a different the sample portion; mounting each punch device containing the sample portion onto the first slide as described herein; pushing the sample portions out of the punch devices using one or more pistons so that the sample portions are positioned onto the first slide as described herein.

In embodiments, the method includes obtaining an image of the tissue sample. The imaging step may be performed with high-resolution techniques, such as fluorescence microscopy, which captures emitted signals from fluorescent particles introduced to specific surfaces of the tissue sample. In embodiments, and to ensure comprehensive visualization, images may be taken across multiple focal planes or cross-sections along the z-axis of the tissue, capturing features at various depths to enable identification of key structures and interfaces. Imaging parameters, including exposure time, gain settings, and focal depth, may be adjusted to optimize contrast and resolution, contributing to the clarity and precision of each acquired image. Obtaining detailed images allows for accurate localization of fluorescent particles relative to the tissue layers and supports subsequent computational analyses. These analyses may include edge detection via the Laplacian operator and variance calculations, instrumental in distinguishing boundaries and measuring distances within the tissue. The imaging process thereby provides a critical foundation for assessing the structural integrity, thickness, and spatial relationships among regions of interest within the tissue sample.

In another aspect is provided a method of making a flow cell assembly. In embodiments, the method includes binding a first slide and a second slide together, wherein the first slide or the second slide includes an inlet port. In embodiments, the first slide includes a polymer, a coupling agent, and/or a tissue. In embodiments, the second slide include an adhesive. In embodiments, the second slide is configured to define a reaction chamber when attached to the first slide. In embodiments, a method of making a flow cell assembly comprises coupling a first slide to a second slide to form a bonded stack defining a reaction chamber therebetween. In embodiments, the method comprises binding the first slide and the second slide together such that the reaction chamber is fluidically coupled to an inlet port disposed on the first slide or the second slide. In embodiments, the inlet port comprises an aperture, via, drilled hole, laser-formed opening, or molded opening extending through at least one of the first slide or the second slide. In embodiments, the method further comprises disposing a polymer on the first slide prior to binding the first slide to the second slide. In embodiments, the polymer comprises a cured polymer, a partially cured polymer, or a polymer precursor configured to cure after assembly. In embodiments, the method further comprises disposing a coupling agent on the first slide prior to binding the first slide to the second slide, wherein the coupling agent promotes adhesion between the first slide and at least one of the polymer or an adhesive. In embodiments, the coupling agent comprises a silane coupling agent, an epoxy-functional coupling agent, an acrylate-functional coupling agent, an amine-functional coupling agent, or a combination thereof. In embodiments, the method further comprises immobilizing one or more tissue sections on the first slide prior to binding the first slide to the second slide. In embodiments, the one or more tissue sections are immobilized to the first slide by at least one of electrostatic attraction, adsorption, covalent attachment, affinity binding, or a coating-mediated bond. In embodiments, the method further comprises disposing an adhesive on the second slide prior to binding the first slide to the second slide. In embodiments, the adhesive comprises a pressure-sensitive adhesive, a heat-activated adhesive, a UV-curable adhesive, a moisture-curable adhesive, or a combination thereof. In embodiments, binding the first slide and the second slide together comprises applying a compressive force to activate the adhesive and form a seal around at least a portion of a perimeter of the reaction chamber. In embodiments, the second slide comprises one or more spacer features configured to set a chamber height of the reaction chamber when attached to the first slide. In embodiments, the reaction chamber has a chamber height from about 10 μm to about 2,000 μm. In embodiments, the reaction chamber comprises one lane, two lanes, three lanes, four lanes, or a plurality of lanes.

In embodiments, affixing the second slide to the first slide includes applying pressure to create a fluidic leak-free seal between the first and second slides. In embodiments, applying pressure forms a bond between the gasket and the first and second slides. In embodiments, affixing the second slide to the first slide includes using a UV curable adhesive attached to the second slide, where the UV curable adhesive is cured when exposed to wavelengths between 365 nm to 380 nm. In embodiments, affixing the second slide to the first slide includes using a UV curable adhesive attached to the second slide, where the UV curable adhesive is cured when exposed to wavelengths between 380 nm to 405 nm. In embodiments, affixing the second slide to the first slide includes using a UV curable adhesive attached to the second slide, where the UV curable adhesive is cured when exposed to wavelength of 405 nm.

In embodiments, the UV-curing adhesive cures when exposed to UV light for about 1 minute, about 5 minutes, about 10 minutes, about 15 minutes, about 20 minutes, about 25 minutes, about 30 minutes, about 40 minutes, about 50 minutes, about 60 minutes, about 70 minutes, about 80 minutes, about 90 minutes, or about 100 minutes. In embodiments, the UV-curing adhesive cures when exposed to UV light for about 10 minutes. In embodiments, the UV-curing adhesive cures when exposed to UV light for about 15 minutes. In embodiments, the UV-curing adhesive cures when exposed to UV light for about 20 minutes. In embodiments, the UV-curing adhesive cures when exposed to UV light for about 30 minutes.

In embodiments, affixing the second slide to the first slide includes using a spacer element. In embodiments, the spacer element includes an adhesive. In embodiments, the spacer element includes a pressure sensitive adhesive (PSA) attached to the second slide, where the pressure sensitive adhesive is affixed with the application of pressure of about 5 psi, 6 psi, 7 psi, 8 psi, 9 psi, 10 psi, 11 psi, 12 psi, 13 psi, 14 psi, 15 psi, 16 psi, 17 psi, 18 psi, 19 psi, 20 psi, or more. In embodiments, the spacer element includes a pressure sensitive adhesive (PSA) attached to the second slide, where the pressure sensitive adhesive is affixed with the application of pressure of about 20 psi, 21 psi, 22 psi, 23 psi, 24 psi, 25 psi, 26 psi, 27 psi, 28 psi, 29 psi, 30 psi, 31 psi, 32 psi, 33 psi, 34 psi, 35 psi, 36 psi, 37 psi, 38 psi, 39 psi, 40 psi, 41 psi, 42 psi, 43 psi, 44 psi, 45 psi, 46 psi, 47 psi, 48 psi, 49 psi, 50 psi, 51 psi, 52 psi, 53 psi, 54 psi, 55 psi, 56 psi, 57 psi, 58 psi, 59 psi, 60 psi, 61 psi, 62 psi, 63 psi, 64 psi, 65 psi, 66 psi, 67 psi, 68 psi, 69 psi, 70 psi, 71 psi, 72 psi, 73 psi, 74 psi, 75 psi, 76 psi, 77 psi, 78 psi, 79 psi, 80 psi, 81 psi, 82 psi, 83 psi, 84 psi, 85 psi, 86 psi, 87 psi, 88 psi, 89 psi, 90 psi, 91 psi, 92 psi, 93 psi, 94 psi, 95 psi, 96 psi, 97 psi, 98 psi, 99 psi, 100 psi, or more. In embodiments, the spacer element includes a pressure sensitive adhesive (PSA) attached to the second slide, where the pressure sensitive adhesive is affixed with the application of pressure between about 10-15 psi. In embodiments, the spacer element includes a pressure sensitive adhesive (PSA) attached to the second slide, where the pressure sensitive adhesive is affixed with the application of pressure between about 10-20 psi. In embodiments, the spacer element includes a pressure sensitive adhesive (PSA) attached to the second slide, where the pressure sensitive adhesive is affixed with the application of pressure of about 10 psi. In embodiments, the spacer element includes a pressure sensitive adhesive (PSA) attached to the second slide, where the pressure sensitive adhesive is affixed with the application of pressure of about 15 psi. In embodiments, the spacer element includes a pressure sensitive adhesive (PSA) attached to the second slide, where the pressure sensitive adhesive is affixed with the application of pressure of about 20 psi. In embodiments, the spacer element includes a pressure sensitive adhesive (PSA) attached to the second slide, where the pressure sensitive adhesive is affixed with the application of pressure of about 25 psi. In embodiments, the spacer element includes a pressure sensitive adhesive (PSA) attached to the second slide, where the pressure sensitive adhesive is affixed with the application of pressure of about 30 psi. In embodiments, affixing includes heating the assembly (e.g., heating to 40, 50, 60, or 70° C.).

In embodiments, affixing the second slide to the first slide placing the first slide described herein and the second slide described herein and applying uniform pressure. The pressure ensures consistent contact across the surfaces, preventing gaps or irregularities in the reaction chamber. The uniform pressure may be applied using a mechanical press, weights, or rollers, depending on the precision required for the assembly. In embodiments, applying substantially uniform pressure comprises applying pressure using a roller assembly as described herein. In embodiments, applying substantially uniform pressure comprises passing the first slide and the second slide through opposed rollers configured to distribute compressive load across a width of the slides. In embodiments, applying substantially uniform pressure comprises applying a compressive force for a dwell time from about 0.1 seconds to about 30 seconds. In embodiments, applying substantially uniform pressure comprises applying a compressive force from about 5 pounds-force to about 60 pounds-force. In embodiments, applying substantially uniform pressure comprises maintaining a substantially constant gap and/or substantially constant force via a preload mechanism comprising at least one of a spring, pneumatic actuator, or hydraulic actuator. In embodiments, applying substantially uniform pressure further comprises aligning the first slide and the second slide using one or more alignment features prior to application of the substantially uniform pressure.

In embodiments, the method includes attaching the first slide and a second slide with a gasket between the first slide and the second slide wherein the gasket is double-sided tape. In embodiments, the method includes attaching the first slide and a second slide with a double-sided tape between the first slide and the second slide, wherein the first slide includes drilled ports. In embodiments, the method includes attaching the first slide and a second slide with a double-sided tape between the first slide and the second slide, wherein the second slide includes drilled ports.

In embodiments, the method includes initially aligning the flow cell with the input tray. In embodiments, the method includes initially aligning the flow cell 112 with the input tray 110 before insertion. Proper alignment positions the flow cell 112 for smooth entry into the roller assembly 125 and prevents misalignment during processing. In embodiments, the input tray 110 may include raised edges, chamfered guides, or alignment rails that assist in positioning the flow cell 112. The surface of the input tray 110 may be composed of low-friction materials, such as PTFE, UHMW polyethylene, or anodized aluminum, allowing the flow cell to slide into place with minimal resistance. In embodiments, alignment features such as mechanical stops, detents, or centering guides may be incorporated into the input tray 110. These features may help direct the flow cell 112 into a predefined path, reducing the likelihood of skewed positioning. In embodiments, the alignment process may be performed manually by the user or assisted by spring-loaded centering pins, magnetic guides, or optical sensors. These elements may help position the flow cell 112 correctly before it enters the roller assembly 125, minimizing variations in compression and adhesive bonding.

In embodiments, the method includes removing the flow cell from the output tray. In embodiments, the method includes removing the flow cell 112 from the output tray 115 after it has been processed. The removal process takes place when the output tray 115 is in the second position, where it extends outwardly through the window 145 in the outer housing 105, making the flow cell 112 accessible to the user. In embodiments, the output tray 115 may incorporate textured surfaces, recessed grips, or an anti-static coating to facilitate handling and prevent accidental slippage during removal. The tray may also feature angled edges or a slight tilt, allowing the flow cell 112 to slide forward naturally for easier retrieval. In embodiments, the method may include grasping and lifting the flow cell 112 manually, or using a vacuum pickup, tweezers, or an automated retrieval system in cases where precision handling is required. The output tray 115 may also be configured with a spring-loaded return mechanism, allowing it to reset to the first position automatically after the flow cell 112 is removed. In embodiments, removal of the flow cell 112 may be followed by inspection, further processing, or transfer to a separate workstation (e.g., a microfluidic device), depending on the application. The processed flow cell 112 may then be stored in a designated holder, staging area, or transport container for subsequent use.

In embodiments, the output tray tilts from the first position to the second position. In embodiments, the output tray 115 tilts as it moves from the first, receiving position to the second, releasing position. The tilting motion repositions the flow cell 112, making it more accessible for removal when the output tray 115 extends outwardly through the window 145 in the outer housing 105. In embodiments, the tilting motion is guided by the output tray actuator 120, which moves along a guide slot 140. The guide slot 140 may be arced, linear with an angled transition, or curvilinear, influencing the degree and direction of tilting. In embodiments, the tilting mechanism may incorporate a pivot point, hinge assembly, or linkage system, allowing controlled movement of the output tray 115. The tilt angle may be designed to position the flow cell 112 at an ergonomic retrieval height or angle, improving handling efficiency. In embodiments, a spring-loaded or counterbalanced mechanism may assist in tilting the output tray 115, providing a controlled transition between positions. A damping element or friction-based pivot may be included to prevent abrupt tilting or unintended movement.

In embodiments, the output tray tilts from a first, receiving position to a second, releasing position. In embodiments, the output tray 115 tilts as the output tray 115 moves from the first position to the second position to reposition the flow cell 112 for user removal. In embodiments, the output tray 115 extends outwardly through a window 145 defined by an outer housing 105 while tilting to present the flow cell 112 at an accessible orientation. In embodiments, the output tray 115 tilts by an angle from about 5 degrees to about 60 degrees relative to the first position. In embodiments, the output tray 115 tilts by an angle from about 10 degrees to about 45 degrees. In embodiments, the output tray 115 tilts by an angle of about 20 degrees. In embodiments, the tilting motion is guided by an output tray actuator 120 that moves along a guide slot 140. In embodiments, the guide slot 140 defines a movement path that is arced, curvilinear, or linear with an angled transition, thereby controlling a direction and degree of tilt of the output tray 115. In embodiments, the guide slot 140 defines a compound path comprising a first substantially linear segment and a second arced segment to provide sequential translation and tilting of the output tray 115. In embodiments, the output tray 115 tilts about a pivot point disposed at a proximal end of the output tray 115 relative to the housing 105. In embodiments, the output tray 115 tilts about a hinge assembly comprising a pin hinge, living hinge, flexure hinge, or a combination thereof. In embodiments, the output tray 115 tilts via a linkage system comprising a four-bar linkage, cam-and-follower linkage, or slider-crank linkage. In embodiments, the tilting motion is configured to position the flow cell 112 at an ergonomic retrieval height and/or retrieval angle to facilitate grasping by a user. In embodiments, the output tray 115 includes a retention feature configured to inhibit unintended sliding of the flow cell 112 during tilting, the retention feature comprising a lip, detent, friction pad, magnet, or resilient clip. In embodiments, the output tray 115 includes a stop surface configured to limit a maximum tilt angle in the second position. In embodiments, a spring-loaded mechanism biases the output tray 115 toward the first position when the output tray actuator 120 is not engaged. In embodiments, the spring-loaded mechanism comprises a torsion spring, extension spring, compression spring, constant-force spring, or a combination thereof. In embodiments, a counterbalance mechanism assists motion of the output tray 115 between the first position and the second position. In embodiments, the counterbalance mechanism comprises a counterweight, gas spring, or elastic element configured to reduce user actuation force. In embodiments, the tilting mechanism includes a damping element configured to reduce a tilt rate of the output tray 115. In embodiments, the damping element comprises a rotary damper, hydraulic damper, elastomer damper, or friction-based pivot. In embodiments, the output tray actuator 120 includes an adjustable resistance feature configured to increase or decrease a force required to tilt the output tray 115. In embodiments, the output tray 115 transitions between positions via a controlled, non-ballistic motion profile to reduce shock loading on the flow cell 112. In embodiments, the output tray 115 includes a latch or detent configured to retain the output tray 115 in the second position until a user releases the latch or detent.

In embodiments, the output tray extends outward through a window in the outer housing to provide access to the flow call via the output tray from a location external to the outer housing. In embodiments, the output tray 115 extends outward through a window 145 in the outer housing 105, positioning the flow cell 112 for retrieval from a location external to the housing. The extension of the output tray 115 allows the user to access the flow cell 112 without needing to reach inside the housing 105, reducing contamination risks and improving ease of operation. In embodiments, the window 145 is dimensioned to accommodate the full extension of the output tray 115 while maintaining structural integrity and preventing unintended exposure to internal components. The window 145 may include a protective lip, reinforced edges, or an optional cover to safeguard the system from dust, debris, or environmental contaminants. In embodiments, the output tray 115 may be configured with a guided extension mechanism, such as sliding rails, pivoting arms, or a linkage system, to provide a controlled outward movement through the window 145. The tray may extend to a predefined stopping point, preventing excessive travel beyond the optimal retrieval position. In embodiments, an optional latch, detent, or spring-loaded return mechanism may be integrated into the output tray 115, allowing it to remain in the extended position until the flow cell 112 is removed. Once the flow cell 112 is retrieved, the output tray 115 may be manually or automatically returned to the first, receiving position within the housing 105.

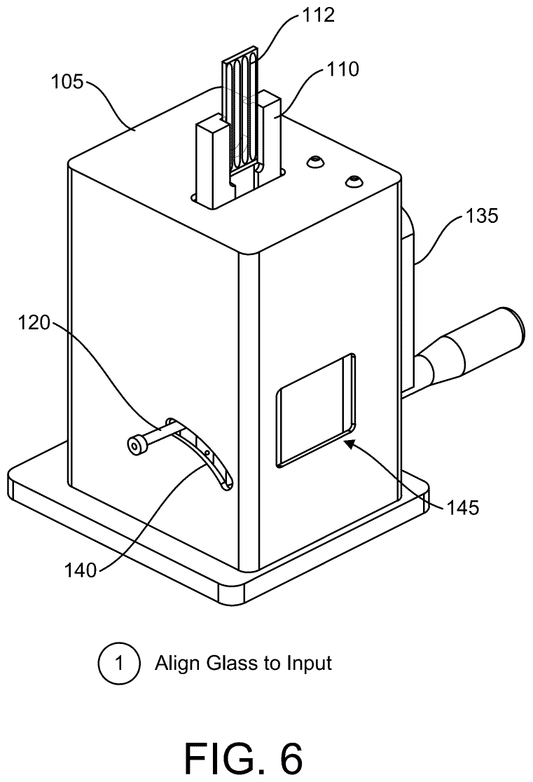

A method of operation of the system of FIG. 1-10 is now described with reference to FIGS. 6 through 10. With reference to FIG. 6, a user aligns and positions the flow cell 112 into the input tray 110. The input tray is fixedly or movably positioned on the housing 105 such that the input tray 110 can receive the flow cell 112 from a user. The input tray 110 can be positioned to slidingly guide the flow cell 112 toward the roller assembly (shown in FIG. 10).

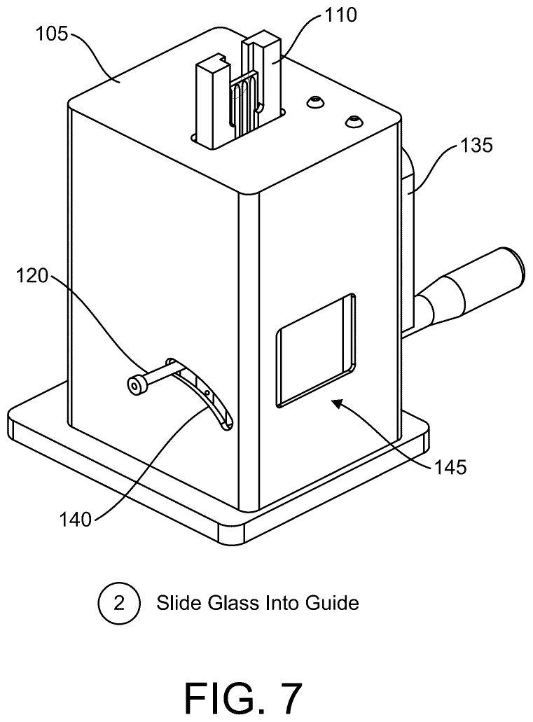

With reference to FIG. 7, the flow cell 112 slides through the input tray 112 toward the internal roller assembly. FIG. 10 shows that the flow cell 112 slides into contact with at least one roller including a first roller 130a and/or a second roller 130b (collectively rollers 130.) The first roller 130a and the second roller 130b define a gap or space therebetween sized and shaped to receive the flow cell 112. The first roller 130a and the second roller 130b are relatively positioned to compress the flow cell between the first roller 130a and the second roller 130b as the flow cell moves from the input tray 110 to the output tray 115. In example implementation, the gap between the rollers is gap is about 1 mm although the size can vary. In example implementation, the first roller 130a and the second roller 130b compress the flow cell 112 so as to apply about a 20 pound force to the flow cell 112 although the compression force can vary. In another example implementation, the first roller and the second roller are made of 80 A durometer urethane.

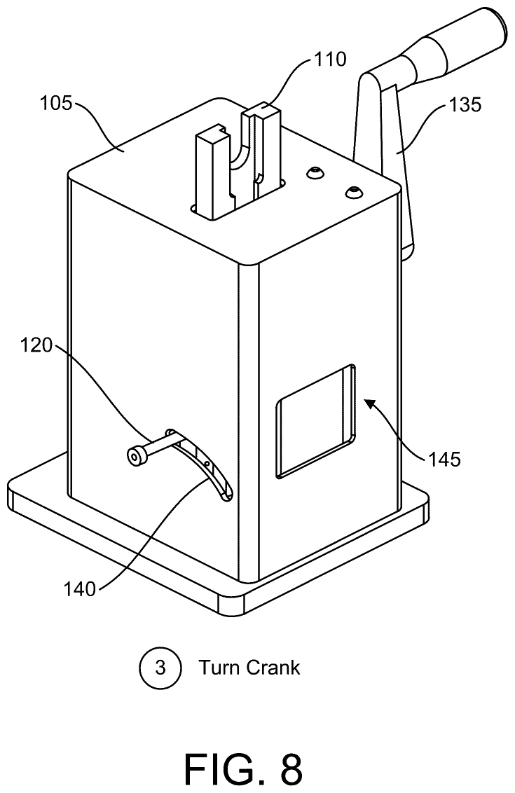

With reference to FIG. 8, the user actuates the roller assembly actuator 135 such as by turning/rotating the actuator in the form of a crank. As mentioned, the rotatable crank is mechanically coupled to a roller shaft of at least one of the rollers 130 such that rotation of the crank causes the roller shaft and roller(s) to rotate. As the rollers 130 rotate, they drive the flow cell 112 from the first tray 110 to the second tray 115.

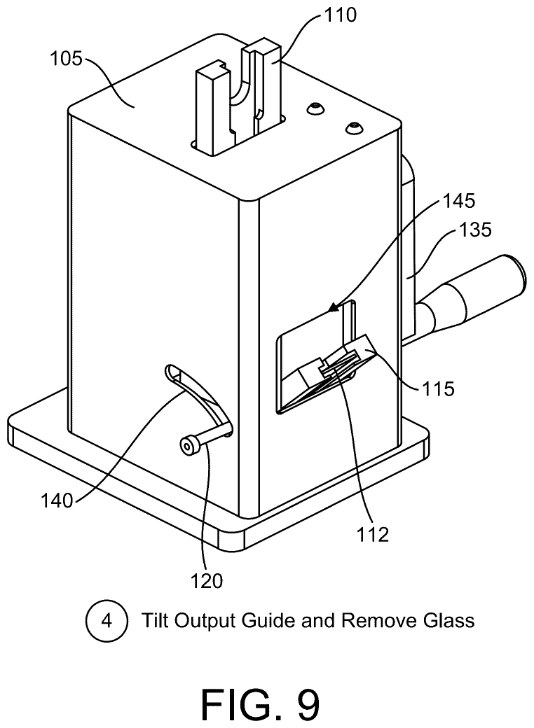

With reference to FIG. 9, the user can actuate the output tray actuator 120 by sliding the output tray actuator 120 along the guide slot 140. This causes the attached output tray 115 to move from the first, receiving position to the second, releasing position. When in the second, releasing position, the output tray 115 extends through and/or can be accessed through a window 145 from a location external the outer housing 105. The user can then access the flow cell 112 and remove it from the output tray 115

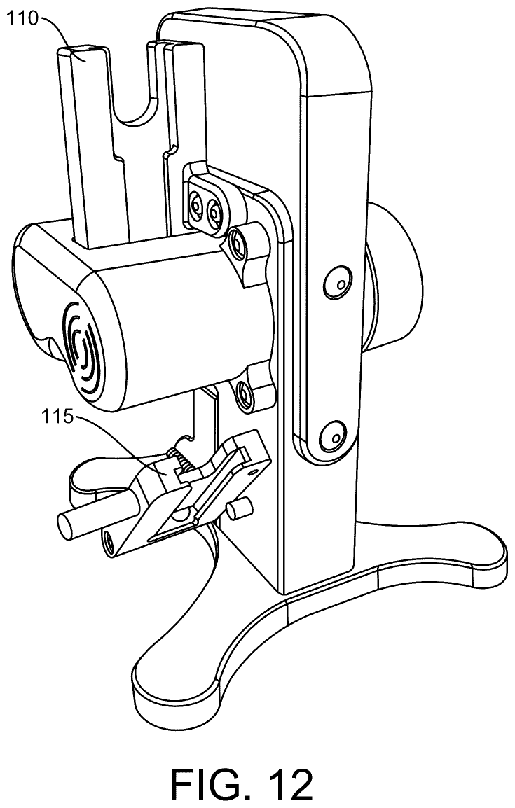

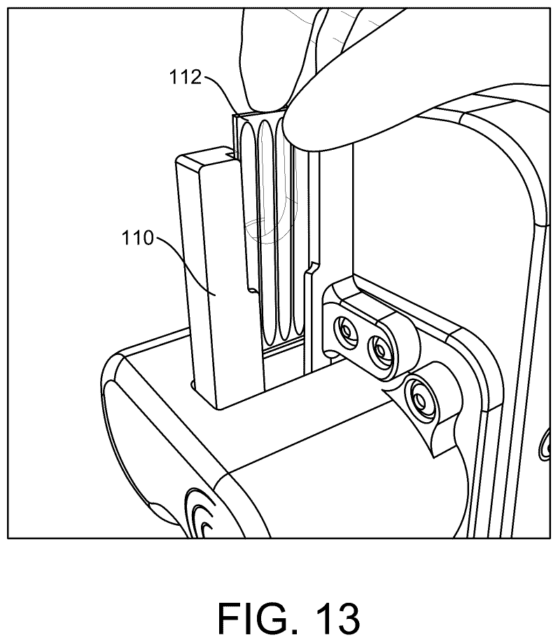

A method of operation of the system of FIG. 11 is now described with reference to FIGS. 12 through 16. The method is also descriptive of the embodiment of FIG. 17. With reference to FIG. 12, a user initially and optionally rotates the output tray 115 forward to a position where the user can confirm there are no previous flow cells to be removed from the output tray 115. The output tray 115 is rotated to a position that permits the user to view whether a flow cell is mounted in the output tray 115. With reference to FIG. 13, the user aligns and positions the flow cell 112 into the input tray 110. The input tray is fixedly or movably positioned on the housing 105 such that the input tray 110 can receive the flow cell 112 from a user such as in a sliding manner. In an implementation, the orientation of the flow cell 112 can vary as it inserted into the input tray 110. For example, the flow cell 112 can be forward facing or rear facing as it is inserted into the input tray 110. As discussed, the input tray 110 can be positioned to slidingly guide the flow cell 112 toward the roller assembly.

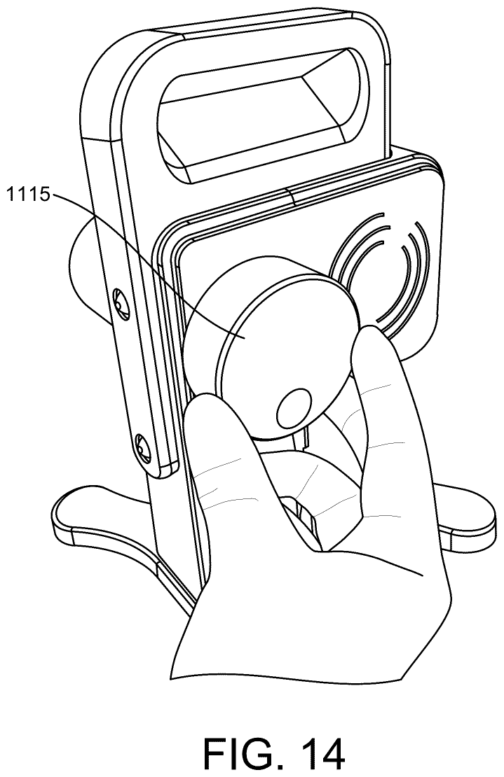

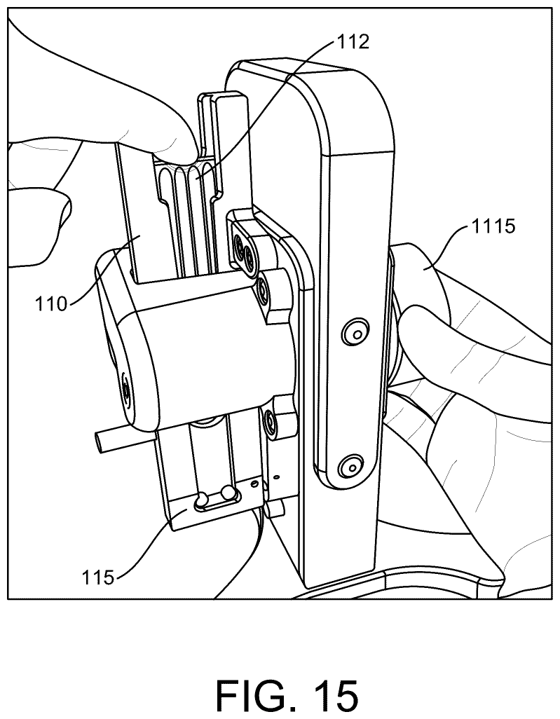

With reference to FIG. 14, the user actuates the roller assembly actuator (knob 1115) such as by turning/rotating the knob 115. In an implementation, the knob is rotated clockwise although a counterclockwise rotation is possible. The knob 1115 is mechanically coupled to a roller shaft of at least one of the rollers 130 such that rotation of the crank causes the roller shaft and roller(s) to rotate. As the rollers 130 rotate, they drive the flow cell 112 from the input tray 110 to the output tray 115. In an implementation, the flow cell completes rolling in 1-2 seconds. As shown in FIG. 15, some downward pressure on the flow cell may be manually applied by a user (such as by pushing the flow cell 112 toward the roller assembly and output tray 115) as the flow cell 112 enters the roller. The user can continue to rotate the knob 1115 while applying pressure. In this manner, the flow cell 112 slides from the input tray 110, through the roller assembly, and into the output tray 115.

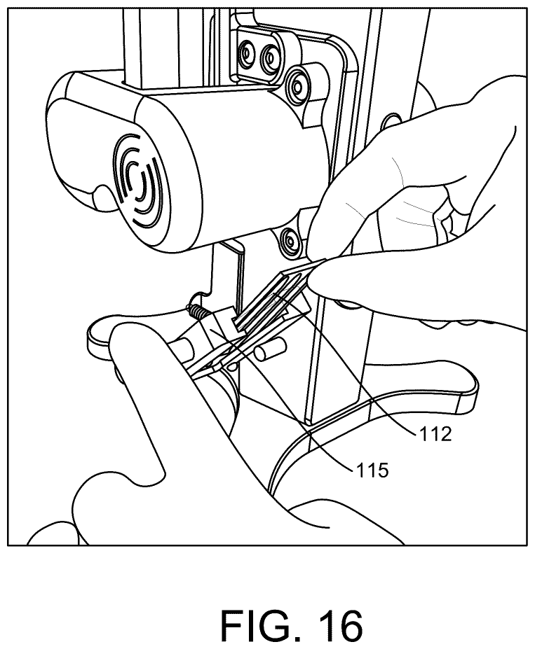

With reference to FIG. 16, the user can then actuate the output tray 115 such as by rotating, pulling or otherwise moving the output tray 115 to cause the output tray 115 to move from the first, receiving position to the second, releasing position, which can be a forward position relative to the first position. When in the second, releasing position, the output tray 115 provides the user with access to the flow cell 112 for removal. The user can then access the flow cell 112 and remove it from the output tray 115, as shown in FIG. 16.

### EXAMPLES

### Example 1. Slide Mating System

The system is designed to apply uniform pressure to a flow cell 112 to facilitate bonding of its components. The process begins with the user aligning and positioning the flow cell 112 into the input tray 110. The input tray 110 is structured to slidingly receive the flow cell 112 and guide it toward the roller assembly 125 within the outer housing 105.

Once positioned, the user initiates movement of the flow cell 112 by actuating the roller assembly actuator 135, which in an example implementation is a crank handle extending outwardly from the housing 105. As the user rotates the crank, it drives at least one roller 130 in the roller assembly 125. The flow cell 112 then enters the gap between a first roller 130a and a second roller 130b, which are spaced apart at approximately 1 mm to accommodate the flow cell 112. The rollers 130a, 130b, made from 80 A durometer urethane, compress the flow cell 112 with a controlled force of approximately 20 lbs, activating of the pressure-sensitive adhesive while minimizing the risk of damage, particularly to two-lane flow cells.

As the rollers 130a, 130b rotate, they drive the flow cell 112 forward from the input tray 110 into the output tray 115. Once the flow cell 112 reaches the output tray 115, the user actuates the output tray actuator 120, which extends outwardly from the housing 105 and slides along a guide slot 140. The guide slot 140 is arced, allowing the output tray 115 to tilt into a release position. This movement repositions the output tray 115 such that it extends outwardly through a window 145 in the housing 105, allowing the user to access and remove the bonded flow cell 112. Throughout the process, the system enables pressure application, efficient flow cell 112 transport, and user-friendly operation.

In embodiments, prior to inserting the flow cell 112 into the input tray 110, the user actuates the output tray actuator 120 to pivot the output tray 115 forward and confirm that no previously processed flow cell is present in the output tray 115, and, if present, remove the previously processed flow cell from the output tray 115. In embodiments, the output tray actuator 120 is spring-loaded such that the output tray actuator 120 is biased toward a default position, and the output tray actuator 120 is held in an actuated position to provide user access to the output tray 115. In embodiments, the input tray 110 comprises an input slot positioned above at least one roller 130 such that the flow cell 112 is receivable from a top side of the system and is guided toward the roller assembly 125. In embodiments, an orientation of the flow cell 112 during insertion into the input tray 110 is non-critical, such that the flow cell 112 is configured to be processed in a plurality of orientations while still being advanced through the roller assembly 125. In embodiments, the roller assembly actuator 135 comprises a knob configured to be pushed and rotated clockwise to rotate at least one roller 130 and draw the flow cell 112 into a nip region between a first roller 130a and a second roller 130b. In embodiments, the roller assembly actuator 135 is rotated in a smooth motion at a moderate speed such that the flow cell 112 completes passage through the roller assembly 125 in about 2 seconds to about 3 seconds. In embodiments, as the flow cell 112 enters the roller assembly 125, the user applies a downward force on the flow cell 112 while continuing to rotate the roller assembly actuator 135 to maintain engagement between the flow cell 112 and the rollers 130a, 130b. In embodiments, continued rotation of the roller assembly actuator 135 drives the flow cell 112 from the input tray 110 into the output tray 115 while the output tray 115 is in the first, receiving position. In embodiments, after the flow cell 112 is received in the output tray 115, the user actuates the output tray actuator 120 to pivot the output tray 115 forward and remove the flow cell 112, wherein the output tray actuator 120 is held forward against spring bias during removal.

In embodiments, after the flow cell 112 is assembled, downstream sample preparation is performed on one or more tissue sections immobilized on the first slide by flowing reagents through the reaction chamber via the inlet port. In embodiments, the reagents comprise one or more affinity reagents configured to bind targets of interest within the tissue, including antibodies, antibody fragments, aptamers, and/or oligonucleotides (e.g., barcoded oligonucleotides). In embodiments, the downstream sample preparation includes one or more cycles of reagent introduction, incubation, and wash steps, wherein the flow cell 112 maintains a defined chamber geometry to promote uniform reagent exposure across the tissue. In embodiments, bound oligonucleotides and/or oligonucleotide-labeled affinity reagents are subjected to an amplification workflow within the reaction chamber, including at least one of enzymatic extension, ligation, rolling circle amplification, PCR-based amplification, or isothermal amplification, thereby increasing detectability of bound targets while maintaining spatial localization within the tissue section.

In embodiments, following sample preparation and amplification, the flow cell 112 is coupled to a G4X Spatial Sequencer for downstream detection. In embodiments, G4X interfaces with the inlet port to deliver sequencing and/or imaging reagents to the reaction chamber and to control fluid exchange, temperature, and/or timing parameters. In embodiments, detection comprises optical detection of labels associated with the bound affinity reagents and/or amplified oligonucleotides, including fluorescence imaging, chemiluminescence imaging, and/or absorbance-based imaging. In embodiments, detection further comprises sequencing-based detection of the oligonucleotides within the flow cell 112 using iterative cycles of reagent delivery and optical readout to generate spatially resolved signal associated with targets of interest in the immobilized tissue, thereby producing spatial maps of target abundance and/or identity.

The subject matter described herein can be embodied in systems, apparatus, methods, and/or articles depending on the desired configuration. The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further variations can be provided in addition to those set forth herein. For example, the implementations described above can be directed to various combinations and subcombinations of the disclosed features and/or combinations and subcombinations of several further features disclosed above. In addition, the logic flow(s) depicted in the accompanying figures and/or described herein do not necessarily require the particular order shown, or sequential order, to achieve desirable results. Other implementations may be within the scope of the following claims.

What is claimed is:

1. A system for applying pressure to flow cell components, the system comprising:
a frame;
an input tray coupled to the frame, the input tray configured to slidingly receive a flow cell formed of a first flow cell component and a second flow cell component positioned in a juxtaposed relationship;
an output tray coupled to the frame, the output tray configured to slidingly receive the flow cell from the input tray;
wherein the output tray can be actuated to move the output tray between a first position configured to receive the flow cell from the input tray and a second position configured to release the flow cell from the frame;
a roller assembly coupled to the frame, the roller assembly including at least one roller configured to apply pressure to compress the first flow cell component and the second flow cell component as the flow cell passes from the input tray to the output tray; and
a roller assembly actuator mechanically coupled to the roller assembly, wherein the roller assembly actuator can be actuated to cause at least one roller of the roller assembly to rotate and drive the flow cell toward the output tray from the input tray.

2. The system of claim 1, further comprising an outer housing coupled to the frame.

3. The system of claim 2, wherein the frame is contained within the housing.

4. The system of claim 1, wherein the first flow cell component is a glass slide component and the second flow cell component is a tissue slide component juxtaposed with the glass slide component.

5. The system of claim 1, wherein the first flow cell component and the second flow cell component are flat, planar bodies.

6. The system of claim 1, wherein the roller assembly includes a first roller and a second roller.

7. The system of claim 6, wherein the first roller and the second roller are relatively positioned to compress the flow cell between the first roller and the second roller as the flow cell moves from the input tray to the output tray.

8. The system of claim 7, wherein a gap is positioned between the first roller and the second roller.

9. The system of claim 8, wherein the gap is about 1 mm.

10. The system of claim 1, wherein the first roller and the second roller compress the flow cell to apply about a 20 pound force or 14.5 to 15 pound force to the flow cell.

11. The system of claim 1, wherein the first roller and the second roller are made of 80 A durometer urethane.

12. The system of claim 2, further comprising an output tray actuator mechanically coupled to the output tray.

13. The system of claim 12, wherein the output tray actuator is a lever.

14. The system of claim 13, wherein the output tray actuator is movably positioned through a guide slot in a side of the outer housing and wherein the output tray actuator slides along the guide slot to cause the output tray to move between the first position and the second position.

15. The system of claim 14, wherein the guide slot is arced such that the output tray tilts into the second position from the first position as the output tray actuator slides along the guide slot.

16. The system of claim 1, wherein the roller assembly actuator is a rotatable knob.

17. The system of claim 1, wherein the roller assembly actuator is a rotatable crank.

18. The system of claim 17, wherein the rotatable crank is mechanically coupled to a roller shaft of at least one of the rollers such that rotation of the crank causes the roller shaft to rotate.

19. The system of claim 1, wherein the input tray is fixedly positioned on the frame such that the input tray can receive the flow cell from a user.

20. The system of claim 19, wherein the input tray is positioned to slidingly guide the flow cell toward the roller assembly.

21. The system of claim 20, wherein the input tray is positioned to slidingly guide the flow cell toward the output tray when the output tray is in the first position.

22. The system of claim 2, wherein the input tray extends outward from a top of the outer housing.

23. The system of claim 1, wherein the output tray rotates between the first position and the second position.

24. The system of claim 1, wherein the output tray is aligned along a common axis with the input tray when the output tray is in the first position such that the flow cell can slide from the input tray into the output tray as a roller of the roller assembly rotates.

25. The system of claim 2, wherein the output tray is positioned to extend outwardly through a window in the outer housing when the output tray is in the second position such that a user can remove the flow cell from the output tray after the flow cell has been transferred from the input tray to the output tray.

26. A method of using the system of claim 1, comprising:
slidingly inserting the flow cell into the input tray;
rotating the roller assembly actuator such that the flow cell slides into the roller assembly and a first roller and a second roller compresses the flow cell therebetween;
further rotating the roller assembly actuator so that the roller assembly drives the flow cell into the output tray while the output tray is in the first position;
actuating the output tray actuator to cause the output tray to move from the first position to the second position.

27. The method of claim 26, further comprising initially aligning the flow cell with the input tray.

28. The method of claim 26, further comprising removing the flow cell from the output tray.

29. The method of claim 26, wherein the output tray tilts from the first position to the second position.

30. The method of claim 26, wherein the output tray extends outward through a window in an outer housing to provide access to the flow call via the output tray from a location external to the outer housing.
